(19) United States
(12) Patent Application Publication
(10) Pub. No.: US 2026/0267712 A1
(43) Pub. Date: Sep. 10, 2026

(54) VIRTUAL NETWORK EMBEDDING FOR DISAGGREGATED DATA CENTER

(71) Applicant: Centre for Intelligent Multidimensional Data Analysis Limited, Pak Shek Kok (HK)

(72) Inventors: Chao Guo, Pak Shek Kok (HK); Jiahe Xu, Pak Shek Kok (HK); Moshe Zukerman, Pak Shek Kok (HK)

(21) Appl. No.: 19/069,681

(22) Filed: Mar. 4, 2025

(51) Int. Cl. G06F 9/50; H04L 12/46

(52) U.S. Cl. CPC G06F 9/5094; H04L 12/4641

(57) ABSTRACT

System and method for virtual network embedding for disaggregated data center. The method includes receiving a virtual network request including information defining a virtual network. The information defining the virtual network includes a set of virtual nodes, a set of virtual links operably connecting the set of virtual nodes, and resource requirements associated with one or more of the virtual nodes. The method includes obtaining a mapping of the virtual network to resources of a disaggregated data center system based at least in part on the information defining the virtual network and an optimization algorithm arranged to optimize power consumption associated with the disaggregated data center system.

### TECHNICAL FIELD

The present invention relates to virtual network embedding for disaggregated data center (i.e., data center with disaggregated architecture or infrastructure).

### BACKGROUND

Data centers with disaggregated architecture may provide improved performance over data centers with server-based architecture. However, existing techniques related to virtual network embedding mainly concern data centers with server-based architecture and may not be suitable (e.g., optimal) for data centers with disaggregated architecture.

### SUMMARY

In a first aspect, there is provided a method, particularly a computer-implemented method, for virtual network embedding. The method comprises receiving a virtual network request including information defining a virtual network. The information defining the virtual network comprises a set of virtual nodes, a set of virtual links operably connecting the set of virtual nodes, and resource requirements associated with one or more of the virtual nodes. The method comprises obtaining a mapping of the virtual network to resources of a disaggregated data center system based at least in part on the information defining the virtual network and an optimization algorithm arranged to optimize power consumption associated with the disaggregated data center system.

In some embodiments, the optimization algorithm is arranged to minimize power consumption associated with the disaggregated data center system.

In some embodiments, the disaggregated data center system comprises a plurality of resource pools and a data center network operably connected with the plurality of resource pools. Each of the resource pool may comprise a plurality of resource nodes, and interconnects arranged to operably connect the plurality of resource nodes. The data center network may comprise a plurality of switch nodes, and a plurality of links arranged to operably connect the plurality of switch nodes and to operably connect the plurality of switch nodes with the resource pools.

In some embodiments, the plurality of resource nodes comprises one or more processor nodes each provided by one or more processors (e.g., CPU) with processing and memory resources, and one or more memory nodes each provided by one or more memory modules (e.g., volatile and/or non-volatile memory) with memory resources. In some embodiments, the plurality of resource nodes may additionally comprise one or more network adaptor nodes each provided by one or more network adaptors (e.g., NIC). In some embodiments, the plurality of resource nodes may additionally comprise one or more accelerator nodes each provided by one or more accelerators (e.g., GPU).

In some embodiments, the plurality of switch nodes comprises one or more switch nodes each provided by a top-of-rack (TOR) switch, one or more switch nodes each provided by an aggregation switch, and one or more switch nodes each provided by a core switch.

In some embodiments, the mapping is arranged to map each of the virtual nodes to, at least, one or more processor nodes and/or one or more memory nodes. In some embodiments, the mapping is arranged to map each of the virtual links to, at least, one or more of the interconnects and/or one or more of the links.

In some embodiments, the mapping is arranged to map each of the virtual nodes to at least two resource nodes of the same resource pool.

In some embodiments, the mapping is arranged to map at least two of the virtual nodes to the same resource node.

In some embodiments, the mapping is arranged to map the virtual nodes to resource nodes of at least two resource pools.

In some embodiments, the optimization algorithm comprises a mixed-integer linear programming (MILP) algorithm.

In some embodiments, the MILP algorithm defines an objective function for optimizing power consumption associated with the resource nodes and the switch nodes in the disaggregated data center system after scheduling the virtual network request, and the MILP algorithm comprises optimizing the objective function.

In some embodiments, the power consumption associated with the resource nodes and the switch nodes comprises static power consumption and dynamic power consumption.

In some embodiments, the MILP algorithm defines one or more constraints associated with mapping of the virtual nodes, one or more constraints associated with mapping of the virtual links, and one or more constraints associated with utilization of one or more of the resource nodes, and the MILP algorithm comprises optimizing the objective function based at least in part on the one or more constraints.

In some embodiments, the optimization algorithm comprises a greedy algorithm.

In some embodiments, the greedy algorithm comprises: a memory demand partition operation, a virtual node mapping operation, and a virtual link mapping operation. The memory demand partition operation may be arranged to divide the memory demand associated with each of the virtual nodes into local memory demand, which can be satisfied by one or more processor nodes of the resource nodes, and remote memory demand, which can be satisfied by one or more memory nodes of the resource nodes.

In some embodiments, the memory demand partition operation comprises a local-memory-first partition operation which prioritizes the local memory demand.

In some embodiments, the memory demand partition operation comprises a remote-memory-first partition operation which prioritizes the remote memory demand.

In some embodiments, the virtual node mapping operation of the greedy algorithm comprises: identifying one or more candidate resource pools for each of the virtual nodes; and starting from the virtual node with the least number of identified candidate resource pools, (i) selecting a resource pool from the one or more candidate resource pools, the selected resource pool is the candidate pool for the highest number of virtual nodes; (ii) identifying all virtual nodes that include the selected resource pool as the candidate resource pool; (iii) for each of the identified virtual nodes, mapping the identified virtual node to, at least, one or more processor nodes and/or one or more memory nodes based at least in part on the resource requirements associated with the virtual node and the remaining capacity of processor and memory nodes in the selected resource pool; and (iv) for each of the mapped virtual node, performing bandwidth allocation operation for allocating bandwidth associated with one or more network adaptor nodes to the mapped virtual node.

In some embodiments, the virtual node mapping operation of the greedy algorithm comprises performing a revoke-and-retry operation if the allocation of bandwidth for the mapped virtual node is unsuccessful. The revoke-and-retry operation may comprise revoking the mapping of the mapped virtual node; performing the bandwidth allocation for another mapped virtual node; and if the mappings of all mapped virtual nodes have been revoked, excluding the selected resource pool from the candidate resource pool and repeating (i) to (iv).

In some embodiments, the virtual node mapping operation of the greedy algorithm comprises: repeating (i) to (iv) until all virtual nodes are mapped.

In some embodiments, the method comprises configuring the disaggregated data center system based at least in part on the mapping to embed or deploy the virtual network.

In some embodiments, the method comprises releasing the resources for the virtual network based at least in part on a service time associated with the virtual network request.

In some embodiments, the disaggregated data center system comprises a composable data center system.

In a second aspect, there is provided a system that comprises at least one processor arranged to perform the method of the first aspect. The at least one processor may be part of the disaggregated data center system.

In a third aspect, there is provided a system comprising at least one processor and at least one memory storing a computer program configured to be executed by the at least one processor. The computer program comprises instructions for performing or facilitating performing of the method of the first aspect. The at least one memory may be at least partly integrated with the at least one processor.

In a fourth aspect, there is provided a carrier medium carrying computer readable instructions arranged to cause at least one processor to perform or facilitate performing of the method of the first aspect. In one example, the carrier medium comprises a computer-readable medium.

In one example, the computer-readable medium is a non-transitory computer-readable storage medium, which stores a computer program executable by the at least one processor. The computer program comprises instructions for performing or facilitating performing of the method of the first aspect.

In a fifth aspect, there is provided a computer program comprising instructions which, when the program is executed by a computer, cause the computer to carry out the method of the first aspect.

Other features and aspects will become apparent by consideration of the following detailed description and the accompanying drawings. Any feature(s) described herein in relation to one aspect or embodiment may be combined with any other feature(s) described herein in relation to any other aspect or embodiment, as appropriate and applicable.

### BRIEF DESCRIPTION OF THE DRAWINGS

Some embodiments will now be described, with reference to the accompanying drawings, in which:

FIG. 1 is a flowchart illustrating a method for virtual network embedding in one embodiment;

FIG. 2 is a schematic diagram illustrating a disaggregated data center system in one embodiment;

FIG. 3 is a schematic diagram illustrating virtual network embedding in a disaggregated data center system in one embodiment;

FIG. 4 is a schematic diagram illustrating a candidate resource pool selection operation in a greedy algorithm for virtual network embedding in one embodiment;

FIG. 5A is a graph showing simulated acceptance ratio versus arrival rate of virtual network requests for an example case-1 disaggregated data center (DDC) obtained using different methods (GRF—greedy algorithm with remote-memory-first operation in one embodiment, GRL—greedy algorithm with local-memory-first operation in one embodiment, MILP—mixed-integer linear programming algorithm in one embodiment, FF—baseline first-fit-based method, and BF—baseline best-fit-based method);

FIG. 5B is a graph showing simulated acceptance ratio versus arrival rate of virtual network requests for another example case-2 disaggregated data center (DDC) obtained using the different methods (GRF, GRL, FF, and BF);

FIG. 6A is a graph showing simulated energy consumption versus arrival rate of virtual network requests for the example case-1 disaggregated data center (DDC) obtained using the different methods (GRF, GRL, MILP, FF, and BF);

FIG. 6B is a graph showing simulated energy consumption versus arrival rate of virtual network requests for the example case-2 disaggregated data center (DDC) obtained using the different methods (GRF, GRL, FF, and BF);

FIG. 7A is a graph showing simulated acceptance ratio versus local memory capacity associated with the CPU nodes for the example case-1 disaggregated data center (DDC) obtained using the different methods (GRF, GRL, MILP, FF, and BF) where arrival rate λ is 1;

FIG. 7B is graph showing simulated acceptance ratio versus local memory capacity associated with the CPU nodes for the example case-1 disaggregated data center (DDC) obtained using the different methods (GRF, GRL, MILP, FF, and BF) where arrival rate λ is 6;

FIG. 7C is a graph showing simulated acceptance ratio versus local memory capacity associated with the CPU nodes for the example case-2 disaggregated data center (DDC) obtained using the different methods (GRF, GRL, FF, and BF) where arrival rate λ is 5;

FIG. 7D is a graph showing simulated acceptance ratio versus local memory capacity associated with the CPU nodes for the example case-2 disaggregated data center (DDC) obtained using the different methods (GRF, GRL, FF, and BF) where arrival rate λ is 40;

FIG. 8A is a graph showing simulated energy consumption versus local memory capacity associated with the CPU nodes for the example case-1 disaggregated data center (DDC) obtained using the different methods (GRF, GRL, MILP, FF, and BF) where arrival rate λ is 1;

FIG. 8B is graph showing simulated energy consumption versus local memory capacity associated with the CPU nodes for the example case-1 disaggregated data center (DDC) obtained using the different methods (GRF, GRL, MILP, FF, and BF) where arrival rate λ0 is 6;

FIG. 8C is a graph showing simulated energy consumption versus local memory capacity associated with the CPU nodes for the example case-2 disaggregated data center (DDC) obtained using the different methods (GRF, GRL, FF, and BF) where arrival rate λ is 5;

FIG. 8D is a graph showing simulated energy consumption versus local memory capacity associated with the CPU nodes for the example case-2 disaggregated data center (DDC) obtained using the different methods (GRF, GRL, FF, and BF) where arrival rate λ is 40;

FIG. 9A is a graph showing simulated acceptance ratio versus bandwidth demand associated with the virtual links (virtual link demand) for the example case-1 disaggregated data center (DDC) obtained using the different methods (GRF, GRL, MILP, FF, and BF) where arrival rate λ is 1;

FIG. 9B is graph showing simulated acceptance ratio versus bandwidth demand associated with the virtual links (virtual link demand) for the example case-1 disaggregated data center (DDC) obtained using the different methods (GRF, GRL, MILP, FF, and BF) where arrival rate λ is 6;

FIG. 9C is a graph showing simulated acceptance ratio versus bandwidth demand associated with the virtual links (virtual link demand) for the example case-2 disaggregated data center (DDC) obtained using the different methods (GRF, GRL, FF, and BF) where arrival rate λ is 5;

FIG. 9D is a graph showing simulated acceptance ratio versus bandwidth demand associated with the virtual links (virtual link demand) for the example case-2 disaggregated data center (DDC) obtained using the different methods (GRF, GRL, FF, and BF) where arrival rate 2 is 40;

FIG. 10A is a graph showing simulated energy consumption versus bandwidth demand associated with the virtual links (virtual link demand) for the example case-1 disaggregated data center (DDC) obtained using the different methods (GRF, GRL, MILP, FF, and BF) where arrival rate λ is 1;

FIG. 10B is graph showing simulated energy consumption versus bandwidth demand associated with the virtual links (virtual link demand) for the example case-1 disaggregated data center (DDC) obtained using the different methods (GRF, GRL, MILP, FF, and BF) where arrival rate λ is 6;

FIG. 10C is a graph showing simulated energy consumption versus bandwidth demand associated with the virtual links (virtual link demand) for the example case-2 disaggregated data center (DDC) obtained using the different methods (GRF, GRL, FF, and BF) where arrival rate λ is 5;

FIG. 10D is a graph showing simulated energy consumption versus bandwidth demand associated with the virtual links (virtual link demand) for the example case-2 disaggregated data center (DDC) obtained using the different methods (GRF, GRL, FF, and BF) where arrival rate λ is 40;

FIG. 11A is a graph showing simulated acceptance ratio versus number of virtual nodes per virtual network for the example case-1 disaggregated data center (DDC) obtained using the different methods (GRF, GRL, MILP, FF, and BF) where arrival rate λ is 1;

FIG. 11B is graph showing simulated acceptance ratio versus number of virtual nodes per virtual network for the example case-1 disaggregated data center (DDC) obtained using the different methods (GRF, GRL, MILP, FF, and BF) where arrival rate λ is 6;

FIG. 11C is a graph showing simulated acceptance ratio versus number of virtual nodes per virtual network for the example case-2 disaggregated data center (DDC) obtained using the different methods (GRF, GRL, FF, and BF) where arrival rate λ is 5;

FIG. 11D is a graph showing simulated acceptance ratio versus number of virtual nodes per virtual network for the example case-2 disaggregated data center (DDC) obtained using the different methods (GRF, GRL, FF, and BF) where arrival rate λ is 40;

FIG. 12A is a graph showing simulated energy consumption versus number of virtual nodes per virtual network for the example case-1 disaggregated data center (DDC) obtained using the different methods (GRF, GRL, MILP, FF, and BF) where arrival rate λ is 1;

FIG. 12B is graph showing simulated energy consumption versus number of virtual nodes per virtual network for the example case-1 disaggregated data center (DDC) obtained using the different methods (GRF, GRL, MILP, FF, and BF) where arrival rate λ is 6;

FIG. 12C is a graph showing simulated energy consumption versus number of virtual nodes per virtual network for the example case-2 disaggregated data center (DDC) obtained using the different methods (GRF, GRL, FF, and BF) where arrival rate λ is 5;

FIG. 12D is a graph showing simulated energy consumption versus number of virtual nodes per virtual network for the example case-2 disaggregated data center (DDC) obtained using the different methods (GRF, GRL, FF, and BF) where arrival rate λ is 40;

FIG. 13A is a graph showing simulated running time of the MILP and GRF methods versus different values of scaling parameter h;

FIG. 13B is a graph showing simulated running time of the GRF method versus different values of scaling parameter h (at a different running time scale from FIG. 13A); and

FIG. 14 is a block diagram of an information processing system that can support virtual network embedding in one embodiment.

### DETAILED DESCRIPTION

Virtual network embedding is a mechanism that enables network virtualization. Generally, virtual network embedding involves optimal allocation of resources from substrate networks to service request in the form of virtual network (virtual network request). Embodiments disclosed herein relate to virtual network embedding for a disaggregated data center (i.e., data center with disaggregated architecture). Data center with disaggregated architecture may be data center with composable architecture (i.e., a disaggregated data center may or may not be a composable data center). Generally, in a disaggregated data center, resources are arranged in resource pools. In some embodiments, there is provided an optimization method that can achieve efficient virtual network embedding for disaggregated data centers. In some embodiments, there is provided an embedding scheme arranged to act on each arriving virtual network request to embed the virtual network with optimal (e.g., minimal) power consumption.

Embodiments disclosed herein concern data centers with next-generation architecture, namely, composable or disaggregated architecture. Traditional data center architectures are based on integrated servers, each containing different types of resources, including computing devices (e.g., CPU, GPU, FPGA, etc.), memory devices (e.g., DRAM, SRAM, etc.), storage devices (e.g., HD, SSD, etc.), and networking devices (e.g., NIC). Also, different servers are independent, i.e., a CPU in one server cannot access memory in another server. Unlike these traditional data center architectures, a composable or disaggregated architecture decouple different devices from independent servers and reassemble them into shared resource pools, e.g., computing pool and memory pool. This may enable flexible system composability. For example, a certain combination of computing, memory, storage, and networking devices can be flexibly selected to form a system.

Embodiments disclosed herein support virtual network embedding for disaggregated data centers. Existing techniques on virtual network embedding may not be applicable to or not suitable for data centers with composable or disaggregated architecture. Embodiments disclosed herein provide techniques for virtual network embedding for disaggregated data centers. The method may consider requests in the form of virtual networks, each including a set of virtual nodes interconnected by a set of virtual links. Each virtual node may require computing or storage resources for executing specific computing tasks. The virtual node may correspond to a virtual machine, a virtual container, or a virtual switch. The virtual links may be used to characterize the communication pattern among the virtual nodes, and the virtual links may be reserved with network bandwidth for supporting the communication pattern. In some embodiments, a virtual network is a request, and different virtual networks may be isolated through server virtualization (virtual machine and virtual container) and network virtualization (software-defined networking or network function virtualization) techniques. This isolation may guarantee that different requests can share the same hardware or resources without knowing each other.

The proliferation of Internet services has led to a significant increase in the volume of data for processing in data centers. In conventional data centers with server-based architecture, servers play a crucial role in providing computing (processing) and storage (memory) resources, and various resources such as processors, memory, network interface cards (NICs), and accelerators are integrated on server motherboards. Such approach of organizing resources in servers has been dominant in conventional data centers. However, this approach has limitations and disadvantages. For example, in the server-based architecture, the close coupling of different resources in a single server may create the risk of resource stranding, which may occur when the utilization of the various resources is imbalanced and may lead to inefficient resource allocation. For example, in the server-based architecture, the process of upgrading hardware may be cost-inefficient due to the different life cycles of different resources. For example, in the server-based architecture, the proliferation of resource types (e.g., multiple types of accelerators) may pose difficulties for managing these resources effectively. Thus, data centers with server-based architecture, with their relatively rigid architecture, may not be able or may not be suitable to support large volume of data traffic in modern applications.

Composable/Disaggregated Infrastructure (CDI) has emerged as a promising architectural approach for next-generation data centers, as data centers with disaggregated architecture (i.e., disaggregated data center) may overcome one or more of the limitations associated with conventional data centers with server-based architecture. In a disaggregated data center, resources in servers may be decoupled and rearranged into distinct resource nodes. These resource nodes are interconnected through high bandwidth and low-latency connections, such as InfiniBand (IB) or Compute Express Link (CXL). Unlike a data center with server-based architecture (with fixed hardware configurations), a disaggregated data center may enable flexible system composition by selecting a desired combination of specific hardware devices. This may overcome one or more limitations associated with data centers with server-based architecture.

The present disclosure relates to virtual network embedding for disaggregated data centers, which may achieve flexible and efficient resource allocation in virtualized networks.

Virtual network embedding can be applied for different networks, such as backbone networks, access networks, and space-air-ground integrated networks. Virtual network embedding can also be applied in data center networks. Terminologies related to virtual network embedding in data center networks include virtual data center embedding, virtual cluster embedding, or like terminologies. The implementation of virtual network embedding for data center networks primarily involves the creation of multiple virtual networks on top of a shared data center network.

Existing techniques for virtual network embedding in data center networks focus on data centers with server-based architecture and not on disaggregated data center, and these existing techniques may not be applicable to or suitable for disaggregated data centers. For example, some of these existing techniques may map a virtual node within a virtual network to a single server to cater to the demands for diverse resources. This strategy may not be applicable to disaggregated data centers in which different resources may be segregated in different resource nodes. The present disclosure provides techniques for facilitating the embedding of virtual networks in a disaggregated (e.g., composable) data center. In the context of virtual network embedding for disaggregated data centers in the present disclosure, a virtual network may include a set of virtual nodes, such as virtual machines, virtual switches, and virtual routers, interconnected by virtual links. Each virtual node may be characterized by its requirements for computing (processing) and storage (memory) resources, and each virtual link may require the allocation of network bandwidth. Different virtual networks may be isolated from each other and may be allocated to different tenants for application deployment.

Virtual network embedding for a data center may aim to maximize the profit or revenue of the data center owner/operator. To achieve this goal, various virtual network embedding strategies such as minimizing costs (typically energy costs), maximizing service acceptance ratio, achieving high service availability, etc., may be considered.

In one embodiment, a scenario in which each virtual network is associated with an independent virtual network request that arrives randomly is considered. In this scenario, upon arrival of the request, its demand and holding time are given. The present disclosure provides an optimization algorithm for embedding the virtual network request. If the embedding is successful, resources are allocated accordingly. If the embedding fails, e.g., due to insufficient resources, the request is rejected. In practice, when the embedding fails, data center owners/operators may increase physical resource capacity by purchasing additional equipment or may rearrange existing workloads to free up resources for accommodating the incoming request, for example. Also, a virtual network request (e.g., the resource requirements) may be changed throughout the service time.

Embodiments disclosed herein provide an optimization algorithm for achieving efficient virtual network embedding for disaggregated data center. Specifically, embodiments disclosed herein provide a scheme that can act upon the arrival of each virtual network request, to provide a way to carry out that service at reduced (e.g., minimized) power consumption. By utilizing this scheme for each incoming request, a high long-term goal of the acceptance ratio over time, defined as the ratio of the number of accepted requests to the total number of arriving requests throughout a long period of time, may be achieved.

As the use of every unit of disaggregated data center resources may be associated with power consumption, reducing power consumption may improve resource efficiency and consequently increase the acceptance ratio as well as reduce cost. Also, achieving a high acceptance ratio may be useful for optimizing the revenue of the data center operator/owner and for maintaining the Quality of Service (QoS) for applications and services hosted in the disaggregated data center. For example, maximizing the acceptance ratio with given limited disaggregated data center resources may imply maximizing the resource utilization within the disaggregated data center, which may be economically beneficial for the data center operator/owner and may enhance the scalability of the disaggregated data center system. Acceptance ratio can be considered as a meaningful data center performance measure.

Techniques for virtual network embedding for data centers with server-based architecture exist. However, these techniques may not be directly applied to virtual network embedding for data centers with disaggregated architecture. On the other hand, techniques related to resource allocation or workload scheduling for disaggregated data centers also exist. However, these techniques do not concern or focus on virtual network embedding for disaggregated data centers. Very few, if any, techniques for virtual network embedding for disaggregated data centers exist. Even if such technique do exist, they may be based on a simplistic assumption that the servers in each rack are disaggregated into a disaggregated rack and each disaggregated rack is regarded as a resource node, hence ignoring the detailed process of resource allocation from the resource modules in a rack to a virtual machine, or they may adopt the one-to-one mapping and map each virtual machine within a virtual network to a different rack. Some embodiments disclosed herein consider a different (e.g., more challenging) situation, where each resource module may be treated as a resource node, a virtual node may be mapped to multiple resource nodes, and virtual nodes within a virtual network may share racks and resource modules to enhance resource efficiency.

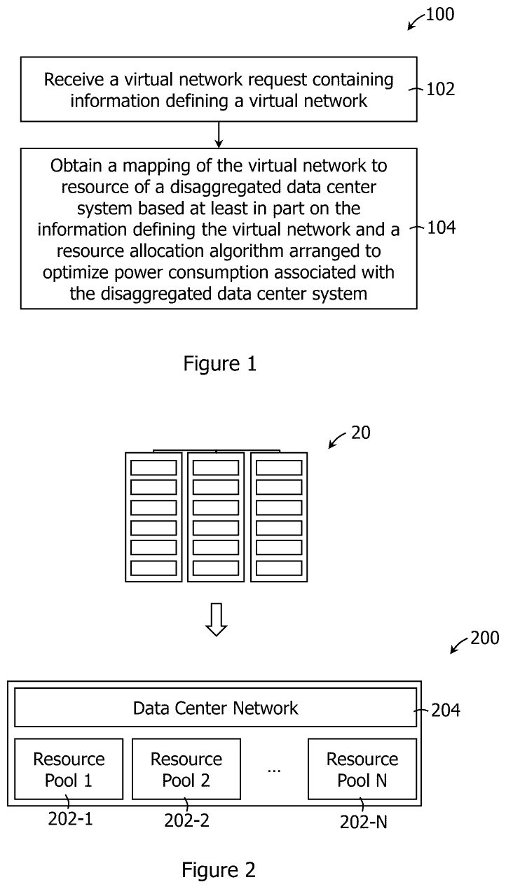

FIG. 1 shows a method 100 for virtual network embedding for a disaggregated data center system in one embodiment. The method 100 is a computer-implemented method, which may be performed by an information processing system such as a computer. The disaggregated data center system may or may not be a composable data center system.

The method 100 includes, in 102, receiving a virtual network request containing information defining a virtual network. The information defining the virtual network includes a set of virtual nodes, a set of virtual links operably connecting the set of virtual nodes, and resource requirements associated with one or more of the virtual nodes. Each virtual node may correspond to at least one of: a virtual switch, a virtual machine, a virtual router, etc. Each virtual link may correspond to a unidirectional link or a bidirectional link. The resource requirements associated with the one or more of the virtual nodes may include processing resource requirement and/or memory resource requirement. The information defining the virtual network may also include bandwidth requirement associated with one or more of the virtual links.

The method 100 includes, in 104, obtaining a mapping of the virtual network to resources of a disaggregated data center system based at least in part on the information defining the virtual network and an optimization algorithm arranged to optimize (e.g., minimize) power consumption associated with the disaggregated data center system. For example, the mapping may be obtained at least in part by applying the information defining the virtual network to the optimization algorithm.

The disaggregated data center system may include at least two resource pools and a data center network operably connected with the resource pools. Each of the resource pool may include resource nodes and interconnects arranged to operably connect the resource nodes. For example, the resource nodes may include one or more processor nodes and one or more memory nodes. Each processor node may be provided by one or more processors (e.g., CPU, MCUU, GPU, NPU, VPU, TPU, logic circuit, Raspberry Pi chip, digital signal processor (DSP), application-specific integrated circuit (ASIC), field-programmable gate array (FPGA), and digital and/or analog circuitry) that can provide processing (and optionally memory) resources. Each memory node may be provided by one or more memory modules (e.g., volatile and/or non-volatile memory modules, such as RAM, DRAM, SRAM, ROM, PROM, EPROM, EEPROM, FRAM, MRAM, FLASH, SSD, NAND, NVDIMM, etc.) that can provide memory resources. The resource nodes may further include one or more network adaptor nodes. Each network adaptor node may be provided by one or more network adaptors (e.g., NIC). The resource nodes may further include one or more accelerator nodes. Each accelerator node may be provided by one or more accelerators (e.g., GPU, NPU, VPU, TPU, etc.). The data center network may include switch nodes and links arranged to operably connect the switch nodes and to operably connect the switch nodes with the resource pools. For example, the switch nodes may include one or more switch nodes each provided by a top-of-rack (TOR) switch, one or more switch nodes each provided by an aggregation switch, and one or more switch nodes each provided by a core switch. The TOR switch(es), the aggregation switch(es), and the core switch(es) may be arranged in tiers in a fat-tree topology.

In some embodiments, the mapping obtained in 104 may be arranged to map each of the virtual nodes to, at least, one or more processor nodes and/or one or more memory nodes. In some embodiments, the mapping obtained in 104 may be arranged to map each of the virtual links to, at least, one or more of the interconnects and/or one or more of the links. In some embodiments, the mapping obtained in 104 may be arranged to map each of the virtual nodes to at least two resource nodes of the same resource pool. In some embodiments, the mapping obtained in 104 may be arranged to map at least two of the virtual nodes to the same resource node. In some embodiments, the mapping obtained in 104 may be arranged to map the virtual nodes to resource nodes of at least two resource pools.

In some embodiments, the optimization algorithm includes a mixed-integer linear programming (MILP) algorithm. The MILP algorithm may define an objective function for optimizing (e.g., minimizing) power consumption associated with the resource nodes and the switch nodes in the disaggregated data center system after scheduling the virtual network request, and the MILP algorithm may include optimizing the objective function. In some embodiments, the power consumption associated with the resource nodes and the switch nodes may include static power consumption and dynamic power consumption. In some embodiments, the MILP algorithm may define one or more constraints associated with mapping of the virtual nodes, one or more constraints associated with mapping of the virtual links, and one or more constraints associated with utilization of one or more of the resource nodes, and the MILP algorithm may include optimizing the objective function based at least in part on the one or more constraints.

In some embodiments, the optimization algorithm includes a greedy algorithm. The greedy algorithm may include a memory demand partition operation, a virtual node mapping operation, and a virtual link mapping operation. The greedy algorithm may be arranged to optimize (e.g., minimize) power consumption associated with the resource nodes and the switch nodes in the disaggregated data center system.

The memory demand partition operation of the greedy algorithm may be arranged to divide the memory demand associated with each of the virtual nodes into local memory demand, which can be satisfied by one or more processor nodes of the resource nodes, and remote memory demand, which can be satisfied by one or more memory nodes of the resource nodes. The memory demand partition operation may include a local-memory-first partition operation, which prioritizes the local memory demand, or a remote-memory-first partition operation, which prioritizes the remote memory demand.

The virtual node mapping operation of the greedy algorithm may include identifying one or more candidate resource pools for each of the virtual nodes. The virtual node mapping operation of the greedy algorithm may further include: starting from the virtual node with the least number of identified candidate resource pools, (i) selecting a resource pool from the one or more candidate resource pools, the selected resource pool is the candidate pool for the highest number of virtual nodes, (ii) identifying all virtual nodes that include the selected resource pool as the candidate resource pool, (iii) for each of the identified virtual nodes, mapping the identified virtual node to, at least, one or more processor nodes and/or one or more memory nodes based at least in part on the resource requirements associated with the virtual node and the remaining capacity of processor and memory nodes in the selected resource pool, and (iv) for each of the mapped virtual node, performing bandwidth allocation operation for allocating bandwidth associated with one or more network adaptor nodes to the mapped virtual node. The virtual node mapping operation of the greedy algorithm may include repeating (i) to (iv) until all virtual nodes are mapped. In some embodiments, the virtual node mapping operation of the greedy algorithm may include performing a revoke-and-retry operation if the allocation of bandwidth for the mapped virtual node is unsuccessful. The revoke-and-retry operation may include revoking the mapping of the mapped virtual node, performing the bandwidth allocation for another mapped virtual node, and if the mappings of all mapped virtual nodes have been revoked, excluding the selected resource pool from the candidate resource pool and repeating (i) to (iv).

In some embodiments, the method 100 may include other steps or operations. For example, the method 100 may include configuring the disaggregated data center system based at least in part on the mapping to embed or deploy the virtual network. For example, the method 100 may include releasing the resources for the virtual network based at least in part on a service time associated with the virtual network request.

FIG. 2 illustrates a disaggregated data center system 200 in one embodiment. The disaggregated data center system includes multiple server racks 20 each including multiple servers. The servers in the server racks 20 are operably connected with each other using suitable hardware and/or software. The resources of the servers are pooled to form resource pools 202-1, 202-2, . . . , 202-N (N is an integer greater than 1) operably connected by the data center network 204. As discussed with reference to 104 in method 100, each resource pool 202-1, 202-2, . . . , 202-N may include resource nodes and interconnects arranged to operably connect the resource nodes and the data center network 204 may include switch nodes and links arranged to operably connect the switch nodes and to operably connect the switch nodes with the resource pools.

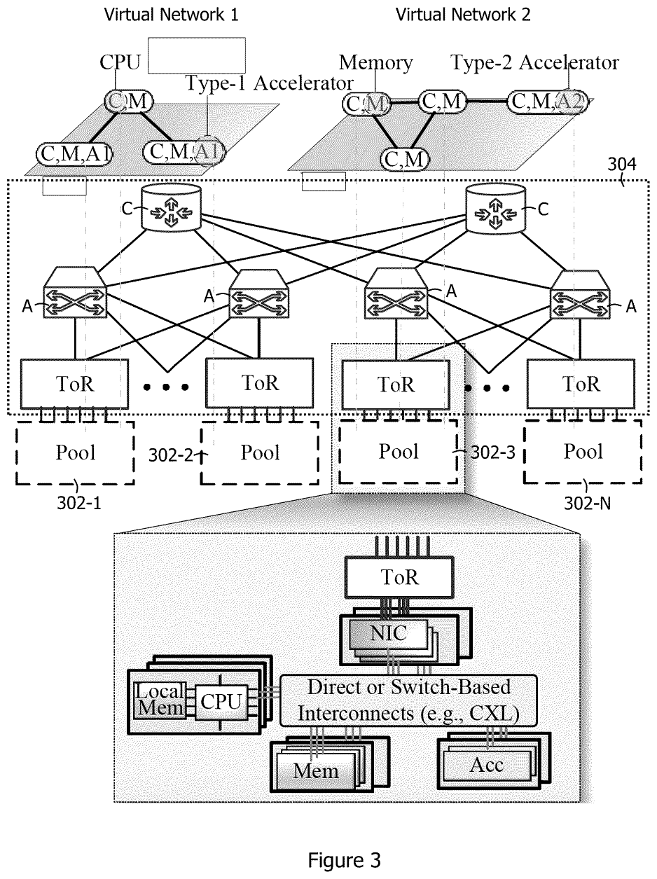

FIG. 3 illustrates virtual network embedding in a disaggregated data center system in one embodiment. The embodiment can be considered as a more specific implementation of method 100.

As shown in FIG. 3, the disaggregated data center in this embodiment includes multiple resource pools 302-1, 302-2, 302-3, . . . , 302-N interconnected through a data center network 304. The data center network 304 represents an architecture used in cloud-based data centers. The architecture organizes switches into a fat-tree topology with three tiers: Top-of-Rack switches TOR at the bottom tier, aggregation switches A at the middle tier, and core switches C at the top tier. Each of the resource pools 302-1, 302-2, 302-3, . . . , 302-N includes multiple resource nodes. The resource nodes include CPU nodes (providing processing resources), memory nodes (providing memory resources), NIC nodes (providing networking resources), and accelerator nodes (providing acceleration resources). A resource node generally provides one specific type of resource. However, in this embodiment, each CPU node provides, in addition to processing resources, a small amount of local memory (Note: the memory provided by the memory nodes can be referred to as remote memory). In some cases, if the CPU nodes considered to provide only CPU cores and no allocable (local) memory (i.e., only processing resources and no memory resources), the design may not be able to meet the stringent bandwidth demand and latency requirements necessary for CPU memory communications. Incorporating local memory in CPU nodes may thus be advantageous in some cases. The resource nodes in a resource pool may be interconnected through interconnects such as CXL. CXL is developed on Peripheral Component Interconnect Express (PCIe) technology, and it enables remote memory nodes and diverse accelerator nodes to cache system memory, which may effectively address challenges related to memory scaling and resource pooling. Additional or alternative interconnects or interconnecting techniques, such as Thymesisflow and/or dRedBox, may be applied to facilitate resource pooling.

FIG. 3 also shows two example virtual networks: virtual network 1 includes three virtual nodes and virtual network 2 includes four virtual nodes. Consider these two virtual networks, a virtual node within a virtual network may require CPU and memory resources and may further require additional types of resources, such as accelerator resources. As shown in FIG. 3, a virtual node can be mapped to different resource nodes in the same resource pool to meet its requirements for different resource types. In this embodiment, the mapping of a virtual node does not cross resource pools. Also, communications between different types of resources allocated to the virtual node may be enabled by intra-pool interconnects. These interconnects may be specifically used for the resource communication in each individual virtual node, while traffic ingressing or egressing a resource pool may be carried by the data center network 304. The connections between NIC nodes and ToR switches may bridge the resource pool and the data center network 304. In this embodiment, virtual nodes within a virtual network are allowed to share a resource pool, which enhances resource efficiency. For example, if two virtual nodes in a virtual network are mapped into a shared pool, they can communicate with each other through the intra-pool interconnects. In this case, there is no need to provide them with network resources, such as NIC bandwidth, even though a virtual link exists between these two virtual nodes. In this embodiment, if two virtual nodes within a virtual network are mapped into separate pools and there exists a virtual link connecting them, NIC bandwidth is allocated to both virtual nodes. In addition, a physical path with reserved bandwidth is established on the data center network for mapping this virtual link.

In one embodiment, a minimum amount of local memory (necessary for a virtual node to maintain acceptable performance levels) is predefined to ensure that the memory allocated to a virtual node from a CPU node surpasses this specified threshold. By incorporating this condition, latency restrictions are implicitly considered hence there is no need to explicitly consider latency requirements.

In one embodiment, both virtual machines and virtual switches are mapped to resource nodes rather than physical switches. The term virtual nodes may be used to collectively refer to virtual machines and virtual switches, with their differences reflected in their respective requirements for resource types and quantities.

A system model associated with the modelling of the disaggregated data center system including the virtual network requests can be defined as follows in one embodiment.

Let [symbol] and [symbol] represent the sets of reals, non-negative reals, positive reals, non-negative integers, and positive integers, respectively.

The system model in this embodiment includes a resource model and a request model. The resource model generally includes a resource node model and a network model.

For the resource node model, define [symbol] as the set of resource pools. Within each pool p∈ [symbol] , there exists multiple resource nodes. Define [symbol] as the set encompassing all resource nodes.

In the disaggregated data center system, there are R distinct resource node types, such as CPU nodes (hosts), memory nodes, NIC nodes, and accelerator nodes (e.g., GPU nodes, NPU nodes, etc). To represent these resource node types, an ordered set [symbol] ={r₁, r₂, r₃, . . . , r_{R}} is introduced. The expression of a type-r node (r∈ [symbol] ) is used to represent a resource node of type r. In particular, the first three types, i.e., types—r₁, r₂, and r₃ nodes, which respectively denote CPU nodes, memory nodes, and NIC nodes. Define

$${\text{?}}_{p}^{r} ⊂ \text{?} ,$$

where r∈ [symbol] and p∈ [symbol] , to represent the set of all type-r nodes in pool p. Each resource node is determined by the three indices: n, r, and p.

Resource nodes of the same type offer the same type(s) of resources. Generally, each resource node includes a single type of resources, except for CPU nodes which includes two types of resources (CPU cores and local memory). Memory nodes provide remote memory.

Thus, memory resources are available from two sources: memory nodes (remote memory) and CPU nodes (local memory). By slightly abusing the notation, [symbol] may also be used to represent the set of resource types. In particular, r₁ denotes the resource type CPU cores as well as the CPU nodes, and r₂ denotes the resource type memory as well as the memory nodes. For example, r₃ represents the resource type NIC bandwidth as well as the NIC nodes.

Denote the remaining capacity of type-r node n in pool p as

$${C}_{r , p}^{n} ∈ {ℕ}_{+} ,$$

for n∈

$${\text{?}}_{p}^{r} ,$$

r∈ [symbol] , and p∈ [symbol] . For CPU nodes

$$n ∈ \text{?} {\text{?}}_{p}^{{r}_{1}} , {\overline{C}}_{r}^{n} ∈ {ℕ}_{+}$$

is further defined as the remaining capacity of local memory. Note that

$${C}_{{r}_{3} , p}^{n} ≡ 0 ,$$

because the network resource requirement of each virtual network request is modelled into traffic matrix.

For the network model, define [symbol] as the set of switch nodes in the data center network. Consider the network graph including NIC nodes and switch nodes. The links in the disaggregated data center system exist between switches as well as between NIC nodes and ToR switches. For any switch or NIC node

$$n ∈ \text{?} ⋃ \{ \text{?} \} ,$$

define

$${ℰ}_{n} ⊂ \text{?} ⋃ \{ \text{?} \}$$

as the set of its neighboring nodes. In this embodiment, bidirectional links are considered, i.e., the link (m, n) and the link (n, m) are considered as distinct links that may have different capacities, for m,

$$n ∈ \text{?} ⋃ \{ \text{?} \} .$$

The remaining capacity of the link (m, n) is denoted as B_{m,n}∈ [symbol] [b/s].

Turning now to the request model associated with the virtual network requests. In this embodiment, the arrival of virtual network requests is assumed to follow a random point process. A dynamic release and reuse of resources is considered, where the service time of a virtual network request is randomly distributed. In this case, when a service from a virtual network request is completed, the resources used for the service are immediately released and made available for use. The remaining capacity variables

$${C}_{r , p}^{n} , {\overline{C}}_{p}^{n} ,$$

and B_{m,n} are updated accordingly. In some embodiments, the method (e.g., algorithm) may treat arriving requests one by one, thus the inter-arrival and service times of the requests can be considered as generally distributed. However, in some cases, they may be treated as exponentially distributed.

Each virtual network request can be abstracted as a collection of multiple virtual nodes (each corresponding to a virtual network function) interconnected by virtual links, with each virtual node resembling a virtual machine or a virtual switch. Let [symbol] be the set of virtual nodes required by the incoming request. A virtual link between virtual nodes u, v∈ [symbol] can be denoted by (u, v).

For each virtual node v∈ [symbol] in the request, define [symbol] \{r₃} as the set of resource types required by the virtual node. In this embodiment, CPU cores and memory resources are always included, namely, r₁, r₂∈ [symbol] for all v∈ [symbol] . However, the necessity of other resource types may depend on the specific requirements of the request. Define

$${D}_{v}^{r} ∈ {ℕ}_{+}$$

as the demand of virtual node v for resources of type r, r∈ [symbol] \{r₃}. Additionally, each virtual node v specifies a threshold for its local memory requirement, denoted by D̅ᵥ∈ [symbol] . This implies that the allocated local memory for virtual node v should not be less than the value of D̅ᵥ.

The traffic matrix can be defined as [symbol] , where each element M_{u,v}∈ [symbol] represents the traffic demand of the virtual link (u, v). Therefore, in this embodiment, a specific virtual network request can be characterized by the tuple

$$( \text{?} , {D}_{v}^{r} , {\overline{D}}_{v} , {M}_{u , v} , t : u , v ∈ \text{?} , r ∈ \text{?} , t > 0 ) ,$$

where t represents the arrival time of the request.

### MILP Algorithm

In one embodiment, in the virtual network embedding approach in the disaggregated data center system, a resource allocation strategy may be adopted to optimize (e.g., minimize) power consumption for each virtual network request individually as it arrives at the system.

In one embodiment, there is provided a MILP formulation (or algorithm) for the optimization problem, the solution of which can enable efficient resource allocation for an incoming virtual network request. The objective function in the MILP formulation may be designed to optimize (e.g., minimize) the total power consumption after scheduling the incoming request. The total power consumption includes the power consumption of resource nodes and switch nodes in the disaggregated data center system.

In this embodiment, upon the arrival of a virtual network request, a resource allocation decision is made. Specifically, for each virtual node within the virtual network request, a suitable set of resource nodes that can provide the required resources is determined. Additionally, mappings for each virtual link between virtual nodes to corresponding physical links are established.

The MILP formulation (or algorithm) in this embodiment includes an objective function defined as follows.

Let

$${W}_{r , p}^{0 , n}$$

denote the static power of type-r node n in pool p, for

$$n ∈ {\text{?}}_{p}^{r} , r ∈ \text{?} ∖ \{ {r}_{3} \} ,$$

and p∈ [symbol] . Similarly, the notation

$${W}_{r , p}^{1 , n}$$

is used to represent the power coefficient of type-r node n in pool p, for

$$n ∈ {𝒩}_{p}^{r} , r ∈ ℛ ∖ \{ {r}_{3} \} ,$$

and p∈ [symbol] . In this embodiment, the power of a CPU node is considered to include two parts: one related to providing CPU cores and the other related to providing local memory resources. The notation

$${\overline{W}}_{p}^{1 , n}$$

is introduced to represent the power coefficient of CPU node n in pool p specifically related to providing local memory. Additionally, Wₙ represents the static power of switch node or NIC node

$$n ∈ 𝒮 ⋃ \{ {⋃}_{p ∈ 𝒫} {𝒩}_{p}^{{r}_{3}} \} ,$$

while W_{n,m} represents the average power of the port of node

$$n ∈ 𝒮 ⋃ \{ {⋃}_{p ∈ 𝒫} {𝒩}_{p}^{{r}_{3}} \}$$

that faces neighboring node m∈εₙ.

In this embodiment, a linear power consumption model is adopted. Specifically, the power of type-r node n in pool p is modeled as the sum of its static power

$${W}_{r , p}^{0 , n}$$

and its dynamic power

$${W}_{r , p}^{1 , n} \cdot {U}_{r , p}^{n} ,$$

where

$${U}_{r , p}^{n} ∈ ℝ$$

is defined as the resource utilization of type-r node n in pool p after the scheduling, for

$$n ∈ {𝒩}_{p}^{r} , r ∈ ℛ ∖ \{ {r}_{3} \} ,$$

and p∈ [symbol] . The local memory usage of a CPU node also contributes to its dynamic power and the contribution is represented by

$${\overline{W}}_{p}^{1 , n} \cdot {\overline{U}}_{p}^{n} ,$$

where

$${\overline{U}}_{p}^{n}$$

represents the local memory utilization of CPU node n in pool p. Similarly, the power of switch or NIC node n is modeled as the sum of its static power Wₙ and the power of each of its active ports W_{n,m}, for

$$n ∈ 𝒮 ⋃ \{ {⋃}_{p ∈ 𝒫} {𝒩}_{p}^{{r}_{3}} \} ,$$

m∈εₙ.

The decision variables are defined as follows:

$${ω}_{r , p}^{n} ∈ \{ 0 , 1 \} ,$$

for

$$n ∈ {𝒩}_{p}^{r} , r ∈ ℛ ∖ \{ {r}_{3} \} ,$$

and p∈ [symbol] , where

$${ω}_{r , p}^{n} = 1$$

if type-r node n in pool p is active after the scheduling, and

$${ω}_{r , p}^{n} = 0$$

otherwise. Additionally, ωₙ∈{0,1}, for

$$n ∈ \text{?} ⋃ \{ \text{?} \} ,$$

where ωₙ=1 if switch or NIC node n is active after the scheduling, and ωₙ=0 otherwise. Furthermore, introduce ω_{n,m}∈{0,1}, for

$$n ∈ \text{?} ⋃ \{ \text{?} \}$$

and m∈εₙ, as a decision variable, where ω_{n,m}=1 if the port of switch or NIC node n that faces neighboring node m is active, and ω_{n,m}=0 otherwise.

Accordingly, the objective function in this embodiment can be formulated as follows.

$$min {\sum }_{n ∈ {𝒩}_{p}^{r} , r ∈ ℛ ∖ \{ {r}_{3} \} , p ∈ 𝒫} ( {W}_{r , p}^{0 , n} \cdot {ω}_{r , p}^{n} + {W}_{r , p}^{1 , n} \cdot {U}_{r , p}^{n} ) + {\sum }_{n ∈ {𝒩}_{p}^{{r}_{1}} , p ∈ 𝒫} {\overline{W}}_{p}^{1 , n} \cdot {\overline{U}}_{p}^{n} + {\sum }_{n ∈ 𝒮 ⋃ \{ {⋃}_{p ∈ 𝒫} {𝒩}_{p}^{{r}_{3}} \}} ( {W}_{n} \cdot {ω}_{n} + {\sum }_{m ∈ {ε}_{n}} {W}_{n , m} \cdot {ω}_{n , m} ) .$$

The MILP formulation (or algorithm) in this embodiment includes constraints on the objective function. These constraints include constraints for virtual node mapping, constraints for virtual link mapping, and constraints for resource node utilization.

First, consider constraints for virtual node mapping in this embodiment.

One constraint for virtual node mapping includes single-node constraints. Generally, a virtual machine may be hosted by a single CPU node. In this embodiment, this constraint is extended to other resource node types, except for memory nodes, as a virtual machine may obtain remote memory resources from multiple memory nodes. Specifically, for any node type r E [symbol] \{2}, virtual node v∈ [symbol] can be mapped to at most a single type-r node. A binary variable

$${x}_{r , p}^{v , n}$$

is introduced, which is equal to 1 if virtual node v is mapped to type-r node n in pool p, and 0 otherwise, for

$$v ∈ \text{?} , n ∈ \text{?} , r ∈ \text{?} ∖ \{ {r}_{2} \}$$

and p∈ [symbol] . Hence, the single node constraint can be formulated as follows, using the decision variables

$${x}_{r , p}^{v , n} .$$

$$\text{?} {x}_{r , p}^{v , n} = 1 , ∀ v ∈ \text{?} , r ∈ \text{?} ∖ \{ {r}_{2} \} \qquad ( 2 )$$

Another constraint for virtual node mapping includes single-pool constraints. In this embodiment, the restriction that a virtual node cannot span multiple resource pools is enforced. This means that a virtual node can only be mapped to resource nodes within a single pool. To achieve this, a binary variable

$${σ}_{v}^{p}$$

is introduced to indicate whether virtual node v is mapped to nodes in pool p. If virtual node v is mapped to nodes in pour p, then

$${σ}_{v}^{p} = 1 ;$$

otherwise,

$${σ}_{v}^{p} = 0.$$

The single pool constraint can be ensured with the following formulation using the decision variables

$${σ}_{v}^{p} :$$

$$\text{?} {σ}_{v}^{p} = 1 , ∀ v ∈ \text{?} \qquad ( 3 )$$

Additionally, the decision variable

$${σ}_{v}^{p}$$

has a direct relationship with the decision variable

$${x}_{r , p}^{v , n}$$

which can be expressed through the following constraint:

$${σ}_{v}^{p} \geq {x}_{r , p}^{v , n} , ∀ v ∈ \text{?} , n ∈ \text{?} , r ∈ \text{?} ∖ \{ {r}_{2} \} , p ∈ \text{?} \qquad ( 4 )$$

Another constraint for virtual node mapping includes NIC allocation constraints. For virtual nodes u, v∈ [symbol] , it is assumed they are mapped into separate pools and there exists a virtual link between them, that is, M_{u,v}>0. In such cases, NIC allocation is necessary for both virtual nodes u and v. To address this, a binary variable, denoted as γ_{u,v}, is introduced. When γ_{u,v}=1, it signifies that the virtual nodes u and v are mapped into different pools, whereas γ_{u,v}=0, otherwise. When executing NIC allocation for virtual nodes u and v, each of them needs to be mapped to a distinct NIC node. To ensure this, the following constraints should be satisfied:

$${M}_{u , v} \cdot {\sum }_{n ∈ {𝒩}_{p}^{r 3} , p ∈ 𝒫} {x}_{{r}_{3} , p}^{v , n} = {M}_{u , v} \cdot {γ}_{u , v} , ∀ u , v ∈ 𝒱 : u \neq v \qquad ( 5 )$$

Additionally, the variable γ_{u,v} has a direct relationship with the variable

$${σ}_{v}^{p} ,$$

which is expressed through the following constraint:

$${γ}_{u , v} \geq {σ}_{u}^{p} - {σ}_{v}^{p} , ∀ u , v ∈ 𝒱 : u \neq v , p ∈ 𝒫 \qquad ( 6 )$$

Another constraint for virtual node mapping includes resource capacity constraints. Let

$${δ}_{r , p}^{v , n} ∈ {ℕ}_{0}$$

represent the amount of memory allocated to virtual node v from type-r node n in pool p, where r∈{r₁, r₂} and

$$n ∈ {𝒩}_{p}^{{r}_{1}} ⋃ {𝒩}_{p}^{{r}_{2}} .$$

Recall that the quantity of resources available on each resource node is limited. To maintain compliance with resource capacity constraints, the decision variable

$${δ}_{r , p}^{v , n}$$

should satisfy the following:

$${\sum }_{v ∈ 𝒱} {δ}_{{r}_{1} , p}^{v , n} \leq {\overline{C}}_{p}^{n} , ∀ n ∈ {𝒩}_{p}^{{r}_{1}} , p ∈ 𝒫 \qquad ( 7 )$$

$$and$$

$${\sum }_{v ∈ 𝒱} {δ}_{{r}_{2} , p}^{v , n} \leq {C}_{{r}_{2} , p}^{n} , ∀ n ∈ {𝒩}_{p}^{{r}_{2}} , p ∈ 𝒫 \qquad ( 8 )$$

Furthermore, for resource node types other than memory nodes and NIC nodes, denoted by r∈ [symbol] \{r₂, r₃}, the decision variables

$${x}_{r , p}^{v , n}$$

should adhere to the following to avoid violating capacity constraints.

$${\sum }_{v ∈ 𝒱} {D}_{v}^{r} \cdot {x}_{r , p}^{v , n} \leq {C}_{r , p}^{n} , ∀ n ∈ {𝒩}_{p}^{r} , r ∈ ℛ ∖ \{ {r}_{2} , {r}_{3} \} , p ∈ 𝒫 \qquad ( 9 )$$

Another constraint for virtual node mapping includes memory allocation constraints. Specifically, the decision variable

$${δ}_{r , p}^{v , n}$$

is further constrained by the memory demand of virtual node v. Recall that

$${D}_{v}^{{r}_{2}}$$

and D̅ᵥ represent the total memory demand and the threshold for local memory demand of virtual node v, respectively. If the incoming virtual network request is accepted, the memory (including remote memory and local memory) allocated to each virtual node v∈ [symbol] should be equal to the total memory demand. To ensure this, the decision variables

$${δ}_{r , p}^{v , n}$$

should satisfy the following:

$${\sum }_{n ∈ {𝒩}_{p}^{r 2} , p ∈ 𝒫} {δ}_{{r}_{2} , p}^{v , n} + {\sum }_{n ∈ {𝒩}_{P}^{{r}_{1}} , p ∈ 𝒫} {δ}_{{r}_{1} , p}^{v , n} = {D}_{v}^{{r}_{2}} , ∀ v ∈ 𝒱 \qquad ( 10 )$$

If virtual node v∈ [symbol] is mapped to type-r₁ node n (a CPU node) in pool p, the allocated local memory

$${δ}_{{r}_{1} , p}^{v , n}$$

should not be less than the predefined threshold D̅ᵥ. On the other hand, if virtual node v is not mapped to type-r₁ node n in pool p, the local memory of the CPU node will not be allocated to the virtual node. Consequently, the decision variables

$${δ}_{{r}_{1} , p}^{v , n} and {x}_{{r}_{1} , p}^{v , n}$$

should satisfy the following:

$${δ}_{{r}_{1} , p}^{v , n} \geq {\overline{D}}_{v} \cdot {x}_{{r}_{1} , p}^{v , n} , ∀ v ∈ \text{?} , n ∈ \text{?} , p ∈ \text{?} and \qquad ( 11 )$$

$${δ}_{{r}_{1} , p}^{v , n} \geq {\overline{C}}_{p}^{n} \cdot {x}_{{r}_{1} , p}^{v , n} , ∀ v ∈ \text{?} , n ∈ \text{?} , p ∈ \text{?} \qquad ( 12 )$$

For type-r₂ nodes (memory nodes), the decision variables

$${δ}_{{r}_{2} , p}^{v , n} and {x}_{{r}_{2} , p}^{v , n}$$

also have a direct relationship as in equation (13). Virtual node v is mapped to type-r₂ node n in pool p as long as the memory node allocates memory resources to the virtual node.

$${C}_{{r}_{2} , p}^{n} \cdot {x}_{{r}_{2} , p}^{v , n} \geq {δ}_{{r}_{2} p}^{v , n} , ∀ v ∈ \text{?} , n ∈ \text{?} , p ∈ \text{?} \qquad ( 13 )$$

In addition,

$${x}_{{r}_{2} , p}^{v , n} \leq {δ}_{{r}_{2} p}^{v , n} , ∀ v ∈ \text{?} , n ∈ \text{?} , p ∈ \text{?} \qquad ( 14 )$$

which ensures that

$${x}_{{r}_{2} , p}^{v , n} = 0$$

when no memory resources from node n in pool p are assigned to virtual node v, for v∈ [symbol] ,

$$n ∈ \text{?}$$

and p∈ [symbol] .

Remote memory allocation may have a larger granularity compared to local memory. For instance, remote memory allocation may be done in 1-GB granularity, which may be larger than the granularity for local memory. A granularity constant G∈ [symbol] is incorporated to denote the level of granularity for remote memory allocation. A decision variable

$${k}_{p}^{v , n} ∈ {ℕ}_{+}$$

is defined as the number of remote memory blocks allocated to virtual node v from memory node

$$n ∈ \text{?}$$

in pool p. Notably, the variable

$${k}_{p}^{v , n}$$

is linked to the variable

$${δ}_{r , p}^{v , n}$$

through the following constraint.

$${δ}_{{r}_{2} , p}^{v , n} = {k}_{p}^{v , n} \cdot G , ∀ v ∈ \text{?} , n ∈ \text{?} , p ∈ \text{?} \qquad ( 15 )$$

Turning now to constraints for virtual link mapping in this embodiment.

One constraint for virtual link mapping includes bandwidth reservation constraints. To route the traffic between virtual node pairs within the virtual network request, the virtual link connecting two virtual nodes should be mapped to a physical path including one or more physical links. To ensure the QoS for the virtual network request, the bandwidth on the mapped links needs to be reserved during the service time. Let b_{m,n}∈ [symbol] represent the amount of bandwidth reserved for the virtual network request on link (m, n). Recall that there is a limit on the bandwidth available on each link, the bandwidth reservation should adhere to the bandwidth remaining capacity constraint. This constraint can be expressed as follows:

$${b}_{m , n} \leq {B}_{m , n} , ∀ m ∈ \text{?} ⋃ \{ \text{?} \} , n ∈ {ℰ}_{m} \qquad ( 16 )$$

Another constraint for virtual link mapping includes traffic routing and flow conservation constraints. In this embodiment, an unsplittable case, in which the traffic through a virtual link is required to take a single physical path and cannot be distributed across multiple paths, is considered. A binary variable

$${e}_{u , v}^{m , n}$$

is introduced, where

$${e}_{u , v}^{m , n} = 1$$

if physical link (m, n) provides bandwidth to virtual link (u, v);

$${e}_{u , v}^{m , n} = 0 ,$$

otherwise. Hence:

$${\sum }_{n ∈ {ℰ}_{m}} {e}_{u , v}^{m , n} \leq 1 , ∀ m ∈ \text{?} ⋃ \{ \text{?} \} , u , v ∈ \text{?} \qquad ( 17 )$$

Define a decision variable

$${z}_{u , v}^{m , n} ∈ {ℕ}_{0}$$

to represent the amount of traffic passing through physical link (m, n), among the total traffic between virtual nodes u and v. Then:

$${b}_{m , n} = {\sum }_{u , v ∈ 𝒱} {z}_{u , v}^{m , n} , ∀ m ∈ 𝒮 ⋃ \{ {⋃}_{p ∈ 𝒫} {𝒩}_{p}^{{r}_{3}} \} , n ∈ {ℰ}_{m} \qquad ( 18 )$$

The variable

$${z}_{u , v}^{m , n}$$

can be directly related to the variable

$${e}_{u , v}^{m , n}$$

by

$${z}_{u , v}^{m , n} = {M}_{u , v} \cdot {e}_{u , v}^{m , n} , ∀ m ∈ 𝒮 ⋃ \{ {⋃}_{p ∈ 𝒫} {𝒩}_{p}^{{r}_{3}} \} , n ∈ {ℰ}_{m} , u , v ∈ 𝒱 \qquad ( 19 )$$

Traffic will flow through switches or NIC nodes

$$n ∈ 𝒮 ⋃ \{ {⋃}_{p ∈ 𝒫} {𝒩}_{p}^{{r}_{3}} \}$$

only if its source and destination virtual nodes are mapped into different pools. For a virtual node pair within the virtual network request, when the source and destination virtual nodes are mapped into different pools, NIC nodes in these two pools are responsible for transmitting and receiving the traffic between the virtual node pair. However, when the source and destination virtual nodes are mapped into the same pool, the traffic is handled internally within the pool and does not traverse the main network. In this case, the memory nodes within the pool serve as traffic transmission and reception points. Thus,

$${z}_{u , , v}^{m , n} = 0$$

for all

$$m ∈ 𝒮 ⋃ \{ {⋃}_{p ∈ 𝒫} {𝒩}_{p}^{{r}_{3}} \}$$

and n∈εₘ.

Define binary variable

$${β}_{u}^{v , n , p}$$

which is equal to 1 if virtual node v is mapped to NIC node n in pool p, while virtual nodes u and v(u≠v) do not share the same pool; and 0 otherwise. Note that this variable satisfies

$${β}_{u}^{v , n , p} = {x}_{{r}_{3} , p}^{v , n} . ( 1 - {σ}_{u}^{p} ) .$$

When addressing the flow conservation constraint for routing traffic between two virtual nodes, it may be useful to consider whether these virtual nodes are mapped into the same or different pools. If the two virtual nodes are mapped into the same pool, their communication will be contained within that pool. On the other hand, if the virtual nodes are mapped into different pools, the traffic will be routed through the main network to establish connectivity. Consequently, to guarantee proper routing, the following constraint should be satisfied:

$${\sum }_{m ∈ {ℰ}_{n}} {z}_{u , v}^{n , m} - {\sum }_{m ∈ {ℰ}_{n}} {z}_{u , v}^{m , n} = \{ \begin{matrix}0 , \\ {M}_{u , v} \cdot ( {β}_{v}^{u , n , p} - {β}_{u}^{v , n , p} )\end{matrix} , \begin{matrix}\begin{matrix}∀ n ∈ 𝒮 \\ ∀ n ∈ {𝒩}_{p}^{{r}_{3}} , p ∈ 𝒫\end{matrix} \\ ∀ u , v ∈ 𝒱 : u \neq v\end{matrix} \qquad ( 20 )$$

To determine the value of the variable

$${β}_{u}^{v , n , p} ,$$

the following constraints should hold.

$$\{ \begin{matrix}{β}_{u}^{v , n , p} \leq {x}_{{r}_{3} , p}^{v , n} \\ {β}_{u}^{v , n , p} \leq {γ}_{u , v} \\ {β}_{u}^{v , n , p} \geq {x}_{{r}_{3} , p}^{v , n} + {γ}_{u , v} - 1\end{matrix} , \qquad ( 21 )$$

$$∀ u , v ∈ 𝒱 : u \neq v , n ∈ {𝒩}_{p}^{{r}_{3}} , p ∈ 𝒫$$

where the first inequality ensures that if virtual node v is not mapped to NIC node n in pool p, then

$${β}_{u}^{v , n , p} = 0 ;$$

the second inequality guarantees that if virtual nodes u and v are mapped into the same pool, then

$${β}_{u}^{v , n , p} = 0 ;$$

the third inequality ensures that if virtual node v is mapped to NIC node n in pool p, while virtual node u does not share a pool with v, then

$${β}_{u}^{v , n , p} = 1 .$$

Turning now to constraints for resource node utilization in this embodiment. Define

$${O}_{r , p}^{n} ∈ {ℕ}_{+} ,$$

for

$$n ∈ {𝒩}_{p}^{r} , r ∈ ℛ ∖ \{ {r}_{3} \} , p ∈ 𝒫 ,$$

as the amount of occupied resources of type-r node n in pool p upon the arrival of the virtual network request. To determine the utilization of type-r node n in pool p, the following equation can be employed:

$${U}_{r , p}^{n} = \{ \begin{matrix}\frac{{O}_{r , p}^{n} + {\sum }_{v ∈ V} ( {D}_{v}^{r} \cdot {x}_{r , p}^{v , n} )}{{O}_{r , p}^{n} + {C}_{r , p}^{n}} & r \neq {r}_{2} \\ \frac{{O}_{r , p}^{n} + {\sum }_{v ∈ V} {δ}_{r , p}^{v , n}}{{O}_{r , p}^{n} + {C}_{r , p}^{n}} & r = {r}_{2} ,\end{matrix} \qquad ( 22 )$$

$$∀ n ∈ {𝒩}_{p}^{r} , r ∈ ℛ \backslash \{ {r}_{3} \} , p ∈ 𝒫$$

Moreover, define

$${\overline{O}}_{p}^{n} ∈ {ℕ}_{+}$$

as the amount of occupied local memory of CPU node n in pool p upon the arrival of the virtual network request. Then the local memory utilization of CPU node n in pool p is calculated according to:

$${\overline{U}}_{p}^{n} = \frac{{\overline{O}}_{p}^{n} + {\sum }_{v ∈ v} {δ}_{{r}_{1} , p}^{v , n}}{{\overline{O}}_{p}^{n} + {\overline{C}}_{p}^{n}} , ∀ p ∈ 𝒫 , n ∈ {𝒩}_{p}^{{r}_{1}} \qquad ( 23 )$$

In addition, type-r node n in pool p is active as long as its resource utilization is greater than zero, which implies the relationship between the variable

$${U}_{r , p}^{n}$$

and the decision variable

$${ω}_{r , p}^{n}$$

as follows.

$${ω}_{r , p}^{n} \geq {U}_{r , p}^{n} , ∀ n ∈ {𝒩}_{p}^{r} , r ∈ ℛ ∖ \{ {r}_{3} \} , p ∈ 𝒫 \qquad ( 24 )$$

Similar to resource node utilization, define U_{m,n} as the bandwidth utilization of link (m, n), for

$$m ∈ 𝒮 ⋃ \{ {⋃}_{p ∈ 𝒫} {𝒩}_{p}^{{r}_{3}} \}$$

and n∈εₘ. Auditionally, define O_{m,n}∈ [symbol] as the amount of occupied bandwidth on link (m, n) when the virtual network request arrives. Thus:

$${U}_{m , n} = \frac{{O}_{m , n} + {\sum }_{u , v ∈ V} {z}_{u , v}^{m , n}}{{O}_{m , n} + {B}_{m , n}} , ∀ m ∈ 𝒮 ⋃ \{ {⋃}_{p ∈ 𝒫} {𝒩}_{p}^{{r}_{3}} \} , n ∈ {ε}_{m} \qquad ( 25 )$$

Whether a switch port is active depends on whether the utilization of any link connecting this port (either an ingress link or an egress link) is non-zero. Accordingly, the following constraint should be satisfied.

$$\{ \begin{matrix}{ω}_{m , n} \geq {U}_{m , n} , \\ {ω}_{m , n} \geq {U}_{n , m} ,\end{matrix} ∀ m ∈ 𝒮 ⋃ \{ {⋃}_{p ∈ 𝒫} {𝒩}_{p}^{{r}_{3}} \} , n ∈ {ε}_{m} \qquad ( 26 )$$

Similarly, a switch is active as long as any one of its switch ports is active. Therefore, the following constraint should hold.

$${ω}_{m} \geq {ω}_{m , n} , ∀ m ∈ 𝒮 ⋃ \{ {⋃}_{p ∈ 𝒫} {𝒩}_{p}^{{r}_{3}} \} , n ∈ {ε}_{m} \qquad ( 27 )$$

### Greedy Algorithm

In one embodiment, there is provided a greedy algorithm (with various variants) for addressing the virtual network embedding in disaggregated data centers. The greedy algorithm may be useful when MILP is not suitable. For example, MILP may not be applicable for large network cases due to its high time complexity, and the greedy algorithm can be applied instead.

Virtual network embedding may generally be decomposed into two sequential steps: virtual node mapping and virtual link mapping. Failure in either of these steps would result in the rejection of the virtual network request. This approach may be quite effective and efficient for the one-to-one mapping style in traditional data centers with server-based architecture, where no two virtual nodes within a virtual network share a server. This is because the NIC port bandwidth required by each virtual node is predetermined, which is equal to the total bandwidth demand of all virtual links connected to the virtual node. However, the present disclosure considers virtual network embedding in disaggregated data centers that permits virtual nodes within a virtual network to share resource pools. Hence, the required NIC port bandwidth is not predetermined and is instead decided by the result of virtual node mapping. For example, if the two virtual nodes of a virtual network are mapped into the same pool, this virtual link will not occupy NIC port bandwidth. Consequently, to avoid embedding failures caused by insufficient NIC port bandwidth, a NIC port bandwidth check in included in the virtual node embedding step. In one embodiment there is provided a solution for the memory allocation.

In this embodiment, the greedy algorithm includes memory demand partition, virtual node mapping, and virtual link mapping.

First, consider the memory demand partition of the greedy algorithm.

In this embodiment, the memory resources including both local memory (provide by CPU nodes) and remote memory (provided by memory nodes). Thus, before executing virtual node mapping for a virtual network request, operation is performed to split the memory demand of each virtual node within the virtual network into local and remote parts. If the virtual node is successfully mapped, the local part will be satisfied by the assigned CPU node whereas the remote part will be sourced from memory nodes. In this context, this embodiment provides two strategies for partitioning memory demand: local-memory-first partition and remote-memory-first partition.

In the local-memory-first partition strategy in one embodiment, the local part is configured to match the memory demand, whereas the remote part is set to 0.

In the remote-memory-first partition strategy in one embodiment, the local part is defined as D̅ᵥ, representing the threshold for local memory demand, and the remote part is set to the remaining memory demand. Algorithm 1 illustrates the remote-memory-first partition strategy (in pseudo-code) in one embodiment.

If the memory demand exceeds the average local memory capacity across CPU nodes, i.e.,

$${D}_{v}^{{r}_{2}} > \frac{{\sum }_{p ∈ P , n ∈ {N}_{p}^{{r}_{1}}} {\overline{C}}_{p}^{n}}{\vert {⋃}_{p ∈ P} {N}_{p}^{{r}_{1}} \vert} ,$$

remote-memory-first partition may be implemented instead of local-memory-first partition, as the local memory capacity available on the assigned CPU node may not be adequate to fulfill the memory demand in such instances.

Algorithm 1 Remote-memory-first Allocation.

```
$Input : Memory demand {D}_{v}^{{r}_{2}} , local memory threshold {\overline{D}}_{v} ,$
    and remote memory granularity G
Output: Local and remote memory parts
  $1 : remote = ⌊ \frac{{D}_{v}^{{r}_{2}}}{G} ⌋ \cdot G$
  $2 : local = {D}_{v}^{{r}_{2}} mod G$
  3: while local < D̅ᵥ
  4: local += G
  5: remote −= G
  6: return local, remote
```

Turning now to the virtual node mapping of the greedy algorithm.

Algorithm 2 illustrates the virtual node mapping process (in pseudo-code) in one embodiment.

Algorithm 2 Virtual Node Mapping.

Input: Set of virtual nodes [symbol] , set of resource pools [symbol] , and

traffic matrix

[symbol]

Output: True/False

| | |
|---|---|
| 1: | [symbol] [v] ← the list of candidate pools for v ∀v ∈ [symbol] |
| 2: | while [symbol] ≠ 0 |
| 3: | v₀ ← [symbol] \| [symbol] [v]\| |
| 4: | if \| [symbol] [v₀]\| = 0 |
| 5: | Revoke all allocated resources |
| 6: | return False |
| 7: | p₀ ← SELECT_POOL( [symbol] [v₀]) |
| 8: | [symbol] _{cand} ← {v \| p₀ ∈ [symbol] [v₀]} |
| 9: | Sort [symbol] _{cand} in ascending order of \| [symbol] [v]\| |
| 10: | while [symbol] _{cand} ≠ Ø |
| 11: | [symbol] ₘₐₚ ← Ø |
| 12: | for v ∈ [symbol] _{cand} |
| 13: | if MAP(v, p₀) = True |
| 14: | Move v from [symbol] _{cand} to [symbol] ₘₐₚ |
| 15: | if [symbol] ₘₐₚ ≠ Ø |
| 16: | break |
| 17: | nic_success ← True |
| 18: | retry ← False |
| 19: | while NIC_ALLOC( [symbol] ₘₐₚ, p₀, retry) = False |
| 20: | retry ← True |
| 21: | vₗₐₛₜ ← last element of [symbol] ₘₐₚ |
| 22: | Revoke mapping of vₗₐₛₜ |
| 23: | Move vₗₐₛₜ to the end of [symbol] _{cand} |
| 24: | if [symbol] map = Ø |
| 25: | nic_success ← False |
| 26: | break |
| 27: | if nic_success = False |
| 28: | break |
| 29: | [symbol] .REMOVE( [symbol] ₘₐₚ) |
| 30: | if retry = False |
| 31: | break |
| 32: | [symbol] [v].REMOVE(p₀), ∀v ∈ [symbol] |
| 33: | return True |

Specifically, the virtual node mapping process begins by identifying the candidate pools for each virtual node (Line 1 of Algorithm 2). A resource pool qualifies as a candidate pool for a virtual node if the resources remaining in that pool are sufficient to fulfill the virtual node's requirements.

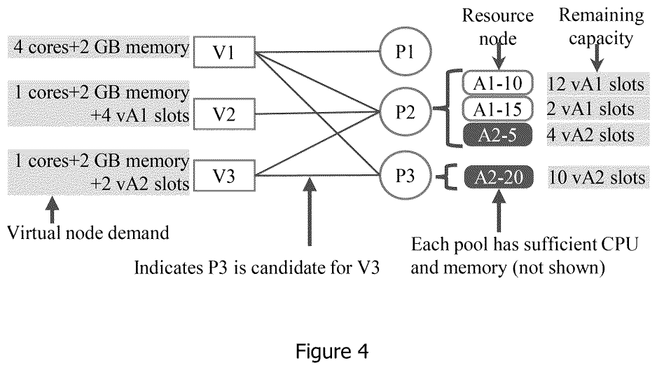

FIG. 4 illustrates an example of candidate pool selection in one embodiment. As shown in FIG. 4, virtual node V1 has three candidate pools as all three pools have enough CPU and memory resources to fulfill its requirements. Virtual node V2 has only one candidate pool P2 because V2 requires a specific accelerator type A1, which is available solely in the A1 node A1-10 in P2. For virtual node V3, its demand for specific accelerator type A2 can be satisfied by node A2-5 in P2 or node A2-20 in P3, resulting in two candidate pools.

In this embodiment, the availability of NIC port bandwidth is not checked when determining candidate pools for a virtual node, because the port bandwidth demand of each virtual node remains indeterminable at this stage. The reason for this uncertainty is that if two virtual nodes are mapped into a single pool, the bandwidth required for the virtual links connecting them will be saved.

For a given virtual network request, to avoid the situation where candidate pools of a virtual node within the virtual network become unavailable because their resources have been allocated to other virtual nodes, this embodiment prioritizes mapping the virtual nodes with the fewest candidate pools. Consequently, the virtual node with the fewest candidate pools is first obtained, denoted as v₀ (Line 3 of Algorithm 2).

Subsequently, a resource pool is selected from the candidate pools of v₀ by calling the SELECT_Pool( ) procedure (Line 7 of Algorithm 2). Specifically, among all candidate pools in the set [symbol] [v₀], the one that is a candidate pool for the highest number of virtual nodes is selected. This decision is made to optimize resource utilization by maximizing the number of virtual nodes sharing the same resource pool, thereby reducing the overall consumption of network resources.

Once the pool is selected (denoted as p₀ in Algorithm 2), it serves not only for mapping v₀ but also to accommodate as many other virtual nodes as possible, provided that they list the selected pool as a candidate pool. Therefore, all virtual nodes whose candidate pools include p₀ are first identified and are put into a list denoted as [symbol] (Line 8 of Algorithm 2). To maintain the principle of prioritizing virtual nodes with the fewest candidate pools, [symbol] is organized in ascending order based on the number of candidate pools they possess (Line 9 of Algorithm 2), and they are then mapped following this order.

Lines 10 to 31 of Algorithm 2 concern virtual node mapping and NIC bandwidth allocation. Initially, an attempt to map the virtual nodes in [symbol] is performed by invoking the MAP( ) procedure, without considering NIC bandwidth demand (Line 13 of Algorithm 2). In particular, the best-fit strategy is applied to map each virtual node. For every required resource type of a virtual node, the resource nodes with the least remaining capacity are prioritized. Virtual nodes that are successfully mapped are then removed from [symbol] and placed into a separate list denoted as [symbol] (Lines 11 and 14 of Algorithm 2).

Subsequently, NIC bandwidth is allocated for the virtual nodes in [symbol] by invoking the NIC_Alloc( ) procedure (Line 19 of Algorithm 2). The fundamental idea of this procedure involves identifying the virtual links with a virtual node in [symbol] and the other not in the list. Each of these virtual links will have a virtual node mapped to p₀ and another virtual node mapped to a different resource pool, which means the virtual link require NIC bandwidth from resource pool p₀ to facilitate communication.

If the NIC bandwidth allocation for virtual nodes in [symbol] is successful, the resource allocation within resource pool p₀ is complete. Therefore, the algorithm proceeds to eliminate all virtual nodes in [symbol] from the virtual node set V (Line 29 of Algorithm 2). This exclusion ensures that these virtual nodes will no longer be considered for mapping in subsequent iterations involving other resource pools. Furthermore, p₀ is removed from the candidate pool set of all the remaining virtual nodes in V (Lines 30 to 32 of Algorithm 2).

If the NIC bandwidth allocation for virtual nodes in [symbol] fails, a revoke-and-retry process is performed (Lines 20 to 26 of Algorithm 2). Specifically, the virtual node that is most recently mapped is identified, which corresponds to the last virtual node in the list [symbol] (denoted as vₗₐₛₜ in Line 21 of Algorithm 2), and the mapping of this virtual node is revoked by releasing the previously assigned resources (Line 22 of Algorithm 2). Subsequently, the algorithm retries the NIC bandwidth allocation for the remaining virtual nodes in [symbol] . The revoke-and-retry process iterates until NIC bandwidth is successfully allocated for the virtual nodes in [symbol] . Alternatively, if the mappings of all virtual nodes in [symbol] have been revoked (Line 24 of Algorithm 2), indicating the ultimate failure of NIC bandwidth allocation (Line 25 of Algorithm 2), the process proceeds to exclude p₀ from the candidate pool set of all virtual nodes (Lines 27, 28, and 32 of Algorithm 2) and initiates the next virtual node mapping iteration (from Line 3 of Algorithm 2).

Implementation of the revoke-and-retry process may be useful. For example, by revoking the mappings of virtual nodes, more CPU and memory resources become available in the current resource pool p₀. As a result, it is possible to map additional virtual nodes in [symbol] into p₀, even though the amount of NIC bandwidth in p₀ remains unchanged as it is before the revoking behavior. For instance, consider a situation where a virtual node's neighbors in the virtual network are already mapped to p₀. Then, mapping this virtual node into p₀ would not require additional NIC bandwidth. Instead, it would conserve the required NIC bandwidth by its neighbors for establishing connections with it.

With the additional NIC bandwidth now available, it is possible that some of the previously revoked virtual nodes can be successfully mapped into p₀. This is why the revoked virtual nodes are not discarded and are instead placed at the end of [symbol] (Line 23 of Algorithm 2). Consequently, following a successful NIC bandwidth allocation for [symbol] , to map additional virtual nodes into p₀, the algorithm repeats the virtual node mapping and NIC bandwidth allocation for [symbol] and p₀ if the revoke-and-retry process is executed during the successful NIC bandwidth allocation. To facilitate this, a Boolean variable named retry is introduced (Line 18 of Algorithm 2) to indicate whether the revoke-and-retry process has been executed. If retry is true, then the process directly enters the next iteration of the while-loop (starting from Line 10 of Algorithm 2), which attempts to map additional virtual nodes from [symbol] into p₀. Conversely, if retry is false, the current while-loop will be terminated (Line 31 of Algorithm 2), and will lead to the exclusion of p₀ from the candidate pool set of the remaining virtual nodes (Line 32 of Algorithm 2).

Algorithm 3 illustrates details of the NIC_Alloc( ) procedure (in pseudo-code) implemented in Algorithm 2 in one embodiment. The NIC_Alloc( ) procedure attempts to assign an appropriate NIC port to each virtual node u∈ [symbol] , ensuring the allocation of its required bandwidth.

Algorithm 3 NIC Bandwidth Allocation.

| Input: [symbol] ₘₐₚ, p₀ | |
|---|---|
| Output: True/False | |
| 1: | previous_success < False |
| 2: | for u ∈ [symbol] ₘₐₚ |
| 3: | for v ∈ u.neighbors |
| 4: | if v has been mapped into p₀ |
| 5: | previous_success ← True |
| 6: | Revoke the previously allocated NIC band- |
| | width to v used for the virtual link (u, v) |
| 7: | [symbol] _{nic} ← the list of NIC nodes in p₀ |
| 8: | for u ∈ [symbol] ₘₐₚ |
| 9: | allocated ← False |
| 10: | Sort [symbol] _{nic} in ascending order of remaining bandwidth |
| 11: | for nic ∈ [symbol] _{nic} |
| 12: | feasible ← True |
| 13: | for v ∈ u.neighbors |
| 14: | if v has been mapped into p₀ |
| 15: | continue |
| 16: | if PORT_BAND_ALLOC(nic, M_{u,v}) = False |
| 17: | feasible ← False |
| 18: | break |
| 19: | if feasible = True |
| 20: | allocated ← True |
| 21: | break |
| 22: | if allocated = False |
| 23: | if previous_success = True |
| 24: | Reallocate the NIC bandwidth that was re- |
| | voked at the beginning |
| 25: | return False |
| 26: | return True |

Consider the NIC bandwidth allocation for a virtual node u∈ [symbol] . Note that certain virtual nodes v within the virtual network may have been successfully mapped into p₀ before, and these virtual nodes may be connected to the virtual node u through virtual links. In this case, it is necessary to first revoke the NIC bandwidth previously allocated to them for establishing virtual links (u, v). This is because the NIC bandwidth can be saved once the virtual node u is also mapped into p₀. Lines 1 to 6 of Algorithm 3 illustrate these.

Subsequently, the best-fit strategy is employed to select a NIC node for the virtual node u∈ [symbol] . In particular, the NIC nodes in p₀ are sorted in ascending order based on the total remaining bandwidth of all ports and select the first feasible NIC node for the virtual node u. For each virtual link connected to the virtual node u, if the other virtual node of the virtual link belongs to a different resource pool, the best-fit strategy is used (based on the remaining bandwidth of each port) to select a port on the NIC node (Lines 9 to 21 of Algorithm 3). Then, from the selected NIC port, the bandwidth that the virtual node u needs to establish that virtual link is allocated (Lines 12 to 18 of Algorithm 3). If none of the ports on this NIC node can support the bandwidth requirements of the virtual node u, the next NIC node in the sorted list may be considered.

If the port bandwidth allocation for any virtual link of any virtual node u∈ [symbol] fails, it would lead to the overall failure of the NIC bandwidth allocation (Lines 22 to 25 of Algorithm 3). In this case, it is necessary to reallocate the NIC bandwidth that is revoked at the beginning of the procedure (Lines 23 to 24 of Algorithm 3).

Turning now to the virtual link mapping of the greedy algorithm.

In the virtual link mapping process in this embodiment, for each virtual link, the NIC nodes and ports assigned to its two virtual nodes are determined in the virtual node mapping process. These two ports are then used as the source and destination to find the shortest path in the disaggregated data center network. In one embodiment, links of which remaining bandwidth is insufficient to support the traffic demand of the virtual link are excluded. For the remaining links, if a link is active (i.e., already carrying loads), the cost is set to the link's utilization, for the purpose of load balancing. For inactive links, the cost is set to 1, as the use of active switch nodes and NIC ports is preferred over inactive ones.

To verify the performance of the methods and algorithm embodiments disclosed herein, example simulations are performed and numerical results considering the performance metrics of energy consumption and acceptance ratio are obtained.

Various settings are configured and used for the example simulations (for obtaining the numerical results). These settings include disaggregated data center system settings, request (virtual network request) settings, baseline techniques applied for comparison, and the simulation environment.

For the disaggregated data center system settings, 5 resource types are considered in the simulation tests: CPU, memory, NIC, A1, and A2, where A1 and A2 represent two different types of accelerators. Two disaggregated data center cases are considered, namely Case-1 disaggregated data center and Case-2 disaggregated data center. The Case-1 disaggregated data center has 4 resource pools, each containing 5 CPU nodes, 1 memory node, 1 NIC node, 2 A1 nodes, and 2 A2 nodes. Following the architecture illustrated in FIG. 3, each pool is equipped with a dedicated ToR switch, resulting in a total of 4 TOR switches. The numbers of aggregation and core switches are both set to 2. Moreover, the three tiers of switches are organized into a Clos topology. The Case-2 disaggregated data center has 20 resource pools, each containing 10 CPU nodes, 2 memory nodes, 2 NIC nodes, 4 A1 nodes, and 4 A2 nodes. Accordingly, there are 20 ToR switches. The numbers of aggregation and core switches are set to 5 and 3, respectively.

Further, it is assumed that each CPU node is equipped with an Intel® Xeon® 6780E Processor and a 16-GB DDR5 DRAM, providing a capacity of 144 CPU cores and 16 GB local memory. The power coefficient of the CPU and local memory in each CPU node is set to 165 W and 1 W, respectively. The CPU power coefficient is set to half of the Thermal Design Power (TDP) of the CPU, while the power coefficient for local memory is derived from the dynamic memory power analyzed in Lee, et. al., “GreenDIMM: OS-assisted DRAM power management for DRAM with a sub-array granularity power-down state” (2021). The CPU node's static power is set to 167 W, obtained by summing half the CPU TDP value and the static memory power (2 W). The capacity of each memory node is configured at 1 TB. The static power and power coefficient of each memory node are set to 70 W and 21 W respectively. For A1 and A2 nodes, the parameters of the INVIDIA A10 GPU module are used. Accordingly, each A1 or A2 node has a capacity of 32 virtual A1 (vA1) or 32 virtual A2 (vA2) slots. The static power and power coefficient of each A1 or A2 node are both set to 150 W, defined as half of the maximum power of the GPU module. For the communication part, each NIC node is considered to be an Intel Network Adapter E810-XXVDA2, featuring a 10 Gb/s capacity per port, 8 W of static power, and a port average power coefficient of 0.45 W. The port average power is calculated from the difference between the maximum power consumption (8.9 W) and the static power, divided by 2 (the total number of ports of the adapter). The bandwidth of each link connecting a NIC node and a ToR switch is configured at 10 Gb/s, aligning with the NIC port capacity. Moreover, links between switches are configured at 40 Gb/s. Cisco's Nexus 9272Q is referred to for switch power configurations. This switch typically consumes an average of 310 W and can support up to 140 10-Gb/s ports or 72 40-Gb/s ports. Half of this typical power is allocated as static power, and the remaining half is distributed evenly among the ports as the port average power. Accordingly, each switch node has a static power of 155 W. The power coefficients of each 10-Gb/s and 40-Gb/s port are set to 1.01 W (155/140) and 2.15 W (155/72), respectively. In addition, the allocation granularity of remote memory is set to 1 GB (i.e., G=1).

Turning now to the request settings. In the simulation tests, the virtual network requests arrive following a Poisson distribution with a certain arrival rate λ, while their holding times follow an exponential distribution with a service rate μ. The mean holding time throughout the simulation is fixed to 1 (1/μ=1). The number of virtual nodes within each virtual network varies from 2 to 10 in the Case-1 disaggregated data center and varies from 2 to 20 in the Case-2 disaggregated data center. Unless specifically stated, all random values in this simulation are assumed to be uniformly generated. Virtual links within each virtual network are randomly generated based on the procedure disclosed in Guo et al., “Temperature-aware virtual data center embedding to avoid hot spots in data centers” (2020). The bandwidth demand of each virtual link varies from 100 to 1000 Mb/s. Additionally, four types of virtual nodes having distinct resource requirements are considered: type 1 (CPU and memory), type 2 (CPU and memory, with high memory demand), type 3 (CPU, memory, and A1), and type 4 (CPU, memory, and A2). Each virtual node within a virtual network randomly belongs to one of these four types. Virtual nodes of all types have CPU demands randomly chosen from {1, 2, 4, 8, 16, 32} cores. The memory demand of a type-2 virtual node is randomly chosen from {64, 128, 256, 512} GB, while for virtual nodes of other types, it ranges from {2, 4, 8, 16, 32} GB. Each type-3 virtual node has an A1 demand chosen from {1, 2, 4, 8, 16} vA1s, and each type-4 virtual node has an A2 demand chosen from {1, 2, 4, 8, 16} vA2s. The local memory threshold of each virtual node ranges from 0 to 16 GB. If a randomly generated value exceeds the virtual node's memory demand, the threshold is adjusted to match the demand.

Regarding baseline (reference) techniques used for comparison, in the example simulations, two baselines are considered for comparison. These two baselines are referred to as the First-Fit-based solution (FF) and Best-Fit-based solution (BF). FF in this example involves two steps for embedding each virtual network request: virtual node mapping and virtual link mapping. In the virtual node mapping step, the solution finds the first feasible pool for each virtual node and the first feasible resource node for each required resource type of the virtual node. During the virtual link mapping, it selects the first feasible NIC node for virtual nodes requiring NIC bandwidth and assigns each virtual link to the shortest path with adequate bandwidth, where all physical links are assigned identical weights. BF in this example is similar to FF, but it employs a best-fit strategy for selecting resource pools, resource nodes, and NIC nodes. It also differs from FF in the routing process by setting the weight of each active physical link to its bandwidth utilization while setting the weight of all inactive links to 1.

In this example, the simulation environment is built using Python, and the disclosed MILP and greedy algorithms (MILP algorithm (MILP), greedy algorithm with remote-memory-first operation (GRF), greedy algorithm with local-memory-first operation (GRL)) and the two baseline methods (FF, BF) are implemented accordingly. The MILP formulation is solved using Gurobi in Python.

A range of performance results are obtained from the simulations. The results classified according to the following independent parameters is provided: arrival rates, local memory capacity of each CPU node, bandwidth demand of each virtual link, and the number of virtual nodes within each virtual network. Further, the running time of the MILP algorithm in on embodiment is compared against the greedy algorithm using remote memory-first partition strategy in one embodiment, which exhibits performance similar to that of the MILP algorithm in various performance comparisons.

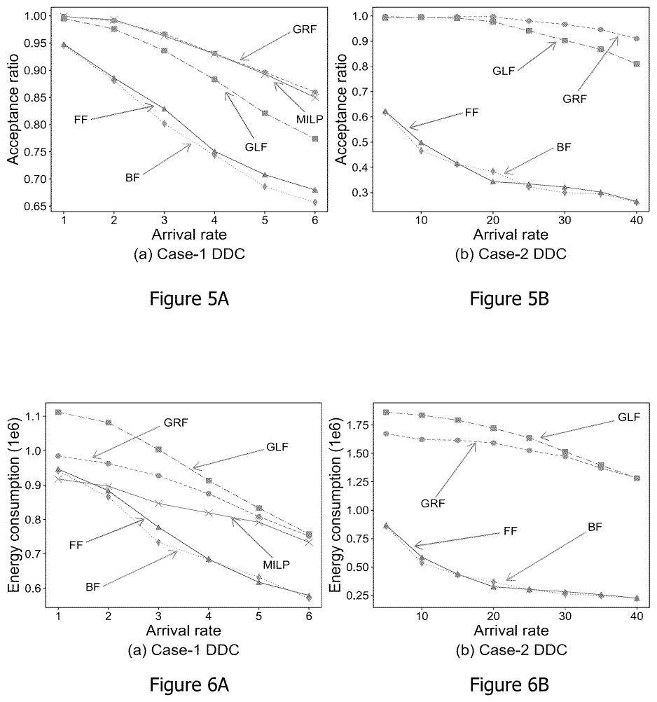

The graphs in FIGS. 5A to 6B illustrate performance results (acceptance ratio, energy consumption) versus arrival rates.

Specifically FIGS. 5A and 5B illustrate how the acceptance ratio varies with the arrival rate of virtual network requests. In the figures, GRF and GLF correspond to the greedy algorithm using the remote-memory first strategy and the greedy algorithm using local-memory-first partition strategy, respectively. MILP, FF, BF correspond to the MILP algorithm, the FF baseline method, and the BF baseline method, respectively.

FIG. 5A shows the acceptance ratio results for the Case-1 disaggregated data center. It can be seen that GRF consistently has a higher acceptance ratio than GLF. Since GLF employs the local-memory-first partition, once a virtual network request arrives, GLF prioritizes the allocation of local memory to the request, which can lead to rapid exhaustion of CPU nodes' local memory. As a result, many subsequent requests may be rejected because their local memory threshold requirements cannot be met. In contrast, GRF adopts the remote-memory-first partition, which is designed to allocate as much remote memory as possible to each request, while ensuring that its local memory threshold requirement is met. Compared to using GLF, using GRF may prevent the rapid exhaustion of local memory in CPU nodes, resulting in better performance in terms of the acceptance ratio. It can also be seen that FF and BF have significantly lower acceptance ratio than MILP, GLF, and GRF. In particular, the differences in acceptance ratio between GRF and the two baselines reach up to 30.9% and 26.6% when compared to BF and FF, respectively, at the arrival rate of 6. This improvement in the acceptance ratio by GRF over BF and FF can be achieved because the baseline algorithms BF and FF do not consider the availability of network resources, especially the bandwidth between NIC nodes and ToR switches, when performing virtual node mapping. In this case, the baseline algorithms BF and FF may map virtual nodes into pools with sufficient computing resources but insufficient NIC bandwidth, resulting in embedding failures. In contrast, GLF and GRF can avoid such failures by involving a careful design of NIC bandwidth allocation in the virtual node mapping step. This may help to proactively avoid failures caused by insufficient bandwidth remaining in the bottom-tier links (i.e., links connecting NIC nodes and ToR switches). It can also be seen that the results of GRF is very close to the optimal solution of MILP, which indicates its efficiency. GRF even outperforms MILP in some cases, such as when the arrival rate is 6. This suggests that while MILP focuses on minimizing the power consumption per arrival, it does not always maximize the acceptance ratio. MILP may instead lead to resource fragmentation as virtual network requests flow in and out of the disaggregated data center system, providing the greedy algorithm with a chance to achieve higher acceptance ratio.

FIG. 5B shows the acceptance ratio results for the Case-2 disaggregated data center. In this case, MILP cannot produce results within an acceptable time period due to the high complexity of MILP, thus the results are not shown (no results for MILP in FIG. 5B). The results in FIG. 5B show similar trends to those in FIG. 5A. GRF performs best, followed by GLF, with both GRF and GLF significantly outperforming FF and BF. The relative differences in acceptance ratio between GRF and the baselines reach 248.7% and 243.4% (compared to BF and FF, respectively), obtained at the arrival rate of 40.

In addition to the acceptance ratio, the overall energy consumption is also considered as the performance metric. The corresponding results are shown in FIGS. 6A and 6B.

FIG. 6A shows the energy consumption results for the Case-1 disaggregated data center. From FIG. 6A, it can be seen that GRF achieves lower energy consumption than GLF, and this gap narrows as the arrival rate increases. This is reasonable as the rapid exhaustion of local memory under the local-memory first partition strategy makes many CPU cores inaccessible, which decreases CPU utilization and necessitates more active nodes to accommodate as many requests as possible. Moreover, as the arrival rate increases, the gap in active nodes between GLF and GRF diminishes, resulting in a reduction in energy consumption difference. When comparing the results of GRF and MILP, it is found that their performance is not as similar as their behaviors in terms of acceptance ratio shown in FIG. 5A. Their difference is up to 7.4%, occurring at the arrival rate of 1. Nevertheless, such a relatively large difference mainly occurs when the system is lightly loaded. As shown in FIG. 6A, as the arrival rate increases from 1 to 6, the gap between GRF and MILP continues to narrow and drops to 2.5% at the arrival rate of 6. When the system is lightly loaded, there may be scenarios where incoming requests can be accommodated without requiring remote memory. However, in such cases, GRF might still allocate remote memory, resulting in a higher number of active memory nodes than MILP, which will lead to an increase in energy consumption. As the arrival rate increases, such situations become less frequent, resulting in a narrower gap between GRF and MILP. It should be noted that memory disaggregation is mainly used to handle the memory scaling issue, which is one of the main problems in current data centers. Hence, in practice, there may be minimal cases where remote memory is not required. Referring back to FIG. 6A, BF and FF exhibit much lower energy consumption than GRF and GLF. This is consistent with the observation in FIG. 5A that both baseline methods show significantly lower acceptance ratio, indicating a lower volume of serviced requests than the GRF and GLF. Consequently, the energy consumption under both baselines is reduced.

FIG. 6B shows the results for the Case-2 disaggregated data center. The results in FIG. 6B show similar trends to those in FIG. 6A.

Apart from the arrival rate, the performance of the disclosed techniques versus local memory capacity in each CPU node is evaluated.

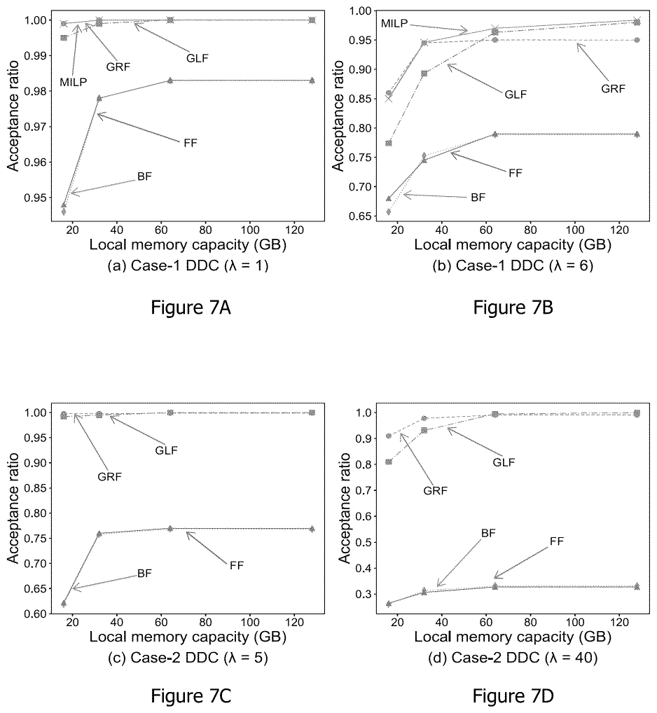

The graphs in FIGS. 7A to 7D illustrate performance results (acceptance ratio) versus local memory capacity in each CPU node.

FIGS. 7A and 7B show the results for the Case-1 disaggregated data center under two different arrival rates, respectively.

FIG. 7A shows the results for the Case-1 disaggregated data center with an arrival rate of 1. This arrival rate corresponds to a very low load for the system. As a result, the acceptance ratio obtained by the GRF, GLF, and MILP are similar and even equal to 100 percent. BF and FF perform much worse than the disclosed techniques, but their acceptance ratio are still high for this case where the disaggregated data center network is small and the arrival rate is low. Their slightly lower acceptance ratio relative to the disclosed algorithms result from the fact that they do not jointly execute virtual node mapping and network resource allocation.

FIG. 7B shows the results for the Case-2 disaggregated data center with an arrival rate of 6. As shown in FIG. 7B, with relatively small local memory capacity, GRF maintains a higher acceptance ratio than GLF, aligning with the trends in FIG. 5A. However, as the local memory capacity increases, the acceptance ratio of GLF surpasses that of GRF. Notably, once the local memory capacity exceeds 32 GB, the acceptance ratio of GRF remains stable. The reason is that GRF prioritizes using remote memory rather than local memory, and its allocation of local memory remains relatively stable but does not increase with the capacity. Accordingly, further increasing local memory capacity does not influence its acceptance ratio performance. In contrast, the acceptance ratio of GLF continues to rise with increasing local memory capacity, eventually exceeding that of GRF. The larger the local memory capacity, the more virtual nodes are allocated only local memory and do not require remote memory. However, as mentioned, memory scaling has reached a bottleneck in data centers with server-based architecture, which is one of the reasons why the disaggregated architecture is required. In addition, it is notable that when the local memory capacity is relatively small, the performance of GRF closely aligns with that of MILP, which indicates the high efficiency of GRF. As the local memory capacity increases, the performance of GLF becomes close to that of MILP due to sufficient availability of local memory. These observations offer some guidance for selecting the appropriate method or technique, e.g., the remote-memory-first or local-memory-first partition, when the local memory capacity varies. FIG. 7B also shows that the disclosed algorithms achieve significantly higher acceptance ratio than FF and BF. When the acceptance ratio of GRF stabilizes, the relative differences in acceptance ratio between GRF and the two baselines are 20.4% and 20.3%, compared to BF and FF, respectively.

FIGS. 7C and 7D show the results for the Case-2 disaggregated data center corresponding to the arrival rates of 5 and 40 respectively. The observed trends in FIGS. 7C and 7D are similar to those in FIGS. 7A and 7B. In particular, the performance of GRF and GLF is very close to the MILP and is significantly better than FF and BF. The relative differences in acceptance ratio between GRF and the two baselines are 198.5% and 203.1% for the Case-1 disaggregated data center and 201.2% and 205.8% for the Case-2 disaggregated data center, compared to BF and FF, respectively. Additionally, it can be seen that the baselines BF and FF are very sensitive to the increase in disaggregated data center size and traffic load, with the acceptance ratio dropping from 98.3% and 98.3% in FIG. 7A to 33.2% and 32.7% in FIG. 7D, whereas MILP, GRF, and GLF are not, as they can maintain high acceptance ratio even for large-sized disaggregated data center and high traffic load.

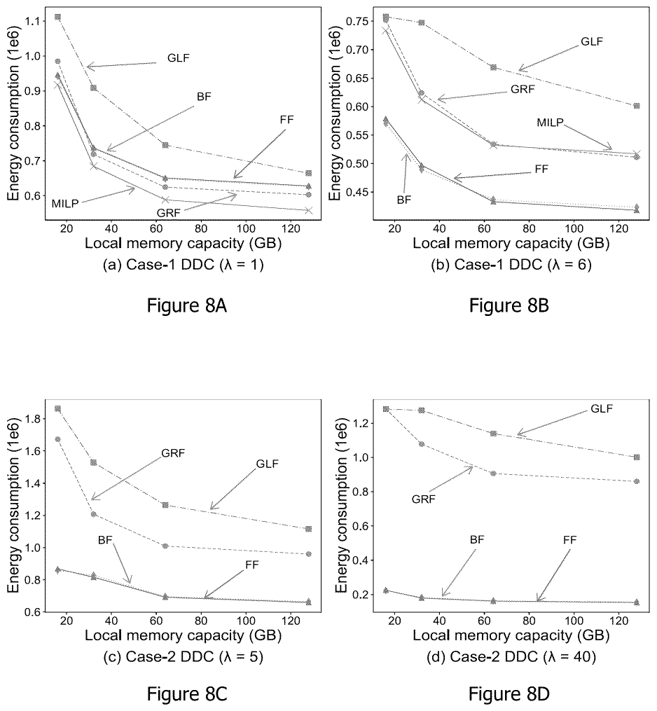

The graphs in FIGS. 8A to 8D illustrate performance results (energy consumption) versus local memory capacity in each CPU node. FIGS. 8A and 8B show the results for the Case-1 disaggregated data center corresponding to the arrival rates of 1 and 6 respectively. FIGS. 8C and 8D show the results for the Case-2 disaggregated data center corresponding to the arrival rates of 5 and 40 respectively.

From FIGS. 8A to 8D, it can be seen that as the local memory capacity increases, the energy consumption of all methods decreases. This is because the increase in local memory capacity can improve the utilization of CPU cores in each CPU node, resulting in improved energy efficiency. It can also be seen that GRF always outperforms GLF, indicating that the remote-memory-first partition strategy achieves higher energy efficiency than the local-memory-first partition strategy. Moreover, the performance of GRF is very similar to MILP, demonstrating its high energy efficiency. The results also show that among all methods, the two baselines achieve the lowest energy consumption, except in FIG. 8A, where MILP and GRF exhibit higher energy consumption. The low energy consumption of the baselines is achieved at the cost of significantly low acceptance ratio (refer to FIGS. 7A to 7D). A zero level of energy consumption can be achieved if the entire disaggregated data center is shut down, resulting in zero acceptance ratio.

The performance of the disclosed techniques versus bandwidth demand of each virtual link is also evaluated.

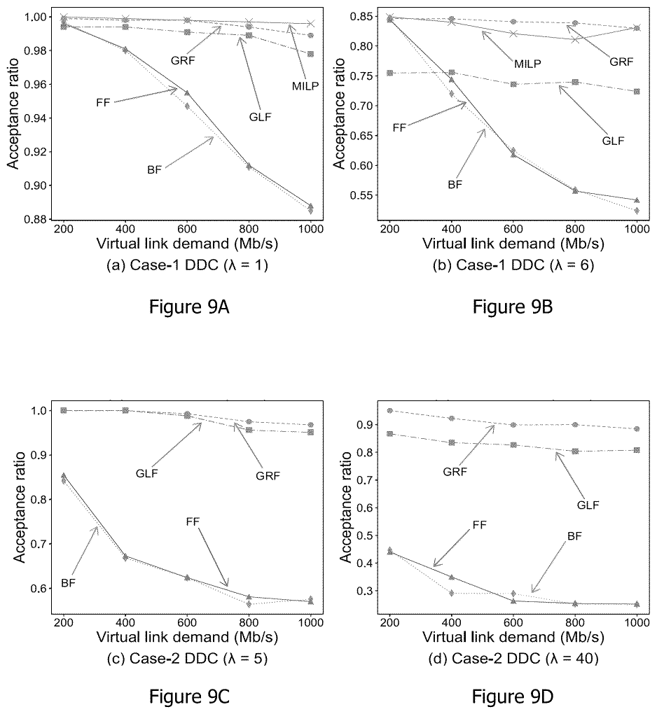

The graphs in FIGS. 9A to 9D illustrate performance results (acceptance ratio) versus the virtual link demand. FIGS. 9A and 9B show the results for the Case-1 disaggregated data center under two different arrival rates 1 and 6, respectively. FIGS. 9C and 9D show the results for the Case-2 disaggregated data center under two different arrival rates 5 and 40, respectively.

From FIGS. 9A to 9D, it can be seen that as the bandwidth demand per virtual link rises, the acceptance ratio achieved by FF and BF decline rapidly. In contrast, the acceptance ratio of GLF, GRF, and MILP remain at a high level, gradually decreasing as the bandwidth demand increases. This trend demonstrates that the pre-allocation process of NIC bandwidth integrated into the disclosed techniques makes them less sensitive to varying traffic demands. Additionally, it can be seen from FIGS. 9A to 9D that GRF generally outperforms GLF, and GRF performs similar to MILP. As shown in the results for the Case-1 disaggregated data center in FIGS. 9A and 9B, FF and BF achieve higher acceptance ratio than GLF at the beginning (i.e. when the bandwidth demand per virtual link is very small). In this case, network resources in the disaggregated data center are sufficient to meet such a low bandwidth demand, reducing the impact of the network capacity constraint on the acceptance ratio. Moreover, both FF and BF adopt the remote-memory-first partition strategy, which enables them to achieve similar performance to GRF at such a low bandwidth demand, resulting in higher acceptance ratio than GLF. However, this phenomenon is not observed in the results for the Case-2 disaggregated data center in FIGS. 9C and 9D, due to a shortage of NIC bandwidth in each resource pool. In the Case-2 disaggregated data center, each resource pool is configured with twice the NIC bandwidth of each pool in the Case-1 disaggregated data center, however, the average bandwidth demand per virtual network entering the Case-2 disaggregated data center far exceeds (beyond twice) that for the Case-1 disaggregated data center. This can be derived from the simulation settings, where the average number of virtual nodes within each virtual network entering the Case-2 disaggregated data center is 1.83 times more than the value for the Case-1 disaggregated data center case. Considering the virtual topology generation procedure used, it is expected that the additional number of virtual links within each virtual network is proportional to the square of the increase in the number of virtual nodes within the virtual network. Therefore, the average number of virtual links within each virtual network entering the Case-2 disaggregated data center is more than three times that for the Case-1 disaggregated data center. Consequently, compared to the Case-1 disaggregated data center, the Case-2 disaggregated data center faces a deficiency in NIC bandwidth per resource pool, which directly results in a significant number of virtual network requests being rejected under FF and BF baselines, thus reducing their lower acceptance ratio.

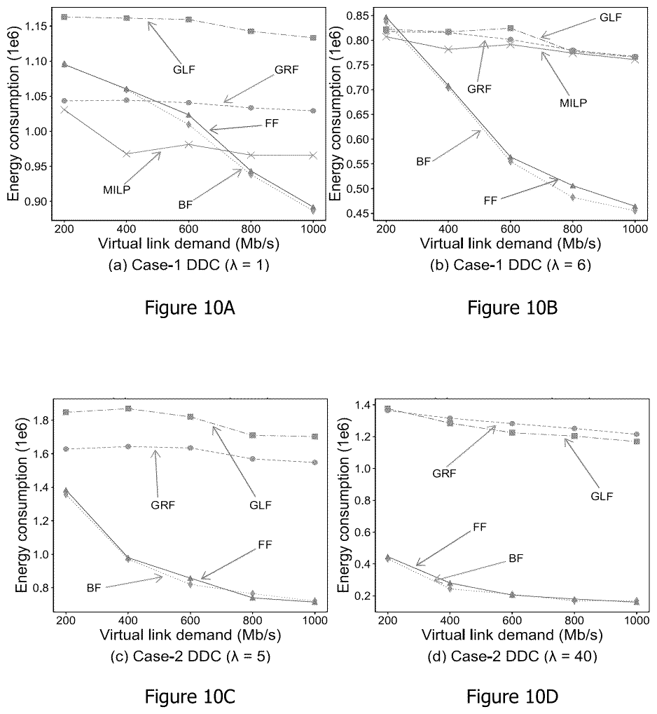

The graphs in FIGS. 10A to 10D illustrate performance results (energy consumption) versus the virtual link demand. FIGS. 10A and 10B show the results for the Case-1 disaggregated data center corresponding to the arrival rates of 1 and 6 respectively. FIGS. 10C and 10D show the results for the Case-2 disaggregated data center corresponding to the arrival rates of 5 and 40 respectively. The energy consumption results in FIGS. 10A to 10D show similar trends as the corresponding acceptance ratio results in FIGS. 9A to 9D. For example, the energy consumption under FF and BF decreases rapidly, while the energy consumption remains relatively stable under GLF, GRF, and MILP. In general, these results are related to the amount of service the disaggregated data center handles. Typically, as the number of accepted virtual network requests increases, the energy consumption increases.

The performance of the disclosed techniques across varying numbers of virtual nodes within each virtual network is also evaluated.

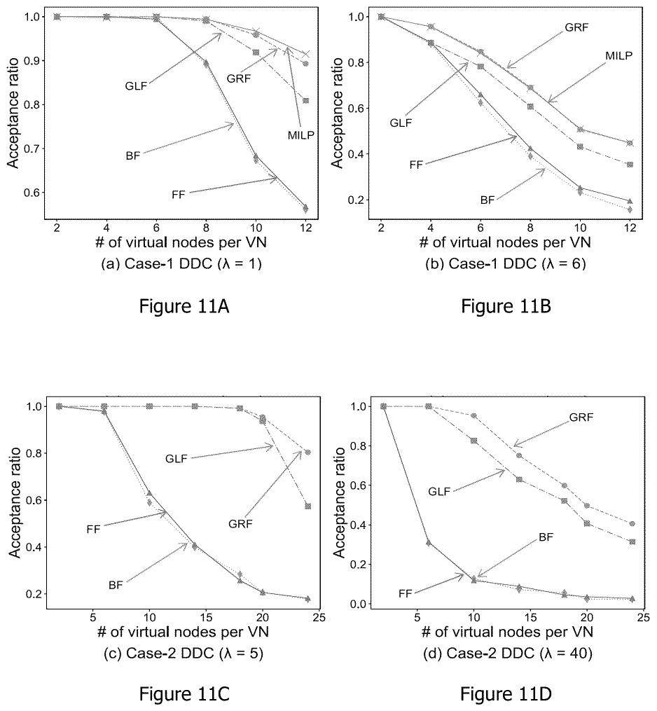

The graphs in FIGS. 11A to 11D illustrate performance results (acceptance ratio) versus the numbers of virtual nodes per virtual network. FIGS. 11A and 11B show the results for the Case-1 disaggregated data center under two different arrival rates 1 and 6, respectively. FIGS. 11C and 11D show the results for the Case-2 disaggregated data center under two different arrival rates 5 and 40, respectively.

As shown in FIGS. 11A to 11D, all the methods obtain an acceptance ratio of 100% when the number of virtual nodes within each virtual network is small, such as 2, 4, or 6 in FIG. 11A. As the number of virtual nodes increases further, these acceptance ratios decline at different rates. Notably, MILP decreases at the slowest rate, followed by GRF and GLF. In contrast, FF and BF experience the most rapid drops, significantly faster than MILP, GRF, and GLF. The relative difference in acceptance ratio of GRF compared to BF and FF reaches up to 59.2% and 57.2% in FIG. 11A, 185.4% and 129.7% in FIG. 11B, 361.4% and 363.6% in FIG. 11C, and 1970.8% and 1280.6% in FIG. 11D. In addition, the performance of GRF is similar to that of MILP, showing the high efficiency of GRF.

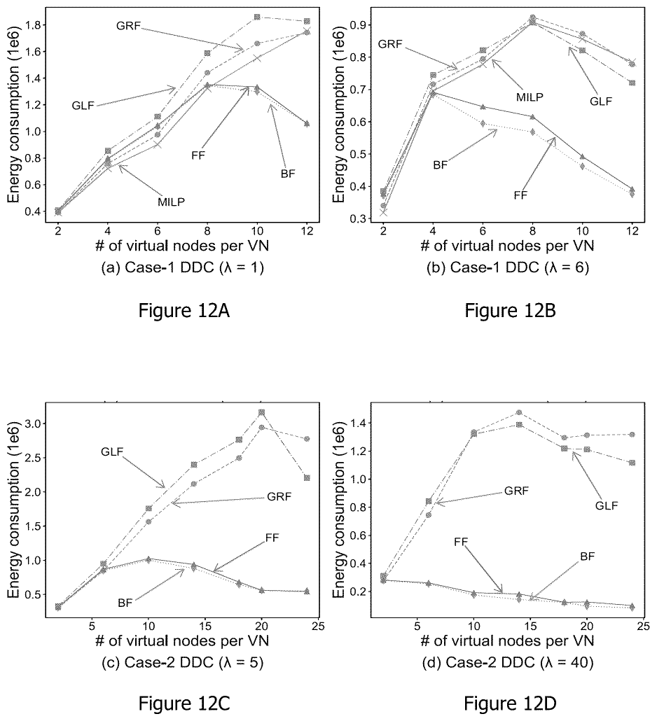

The graphs in FIGS. 12A to 12D illustrate performance results (energy consumption) versus the numbers of virtual nodes per virtual network. FIGS. 12A and 12B show the results for the Case-1 disaggregated data center under two different arrival rates 1 and 6, respectively. FIGS. 12C and 12D show the results for the Case-2 disaggregated data center under two different arrival rates 5 and 40, respectively.

The energy consumption results in FIGS. 12A to 12D exhibit different trends compared to the acceptance ratio results in FIGS. 11A to 11D. When the number of virtual nodes per virtual network is less than a certain value, the energy consumption increases with the number of virtual nodes per virtual network. However, once the certain value is surpassed, a further increase in the number of virtual nodes per virtual network will lead to a decrease in energy consumption. The reason is that when the number of virtual nodes within each virtual network is small, the disaggregated data center system has sufficient resources. Accordingly, the successful accommodation of service volume keeps rising, resulting in increasing energy consumption. However, when the number of virtual nodes within each virtual network is very high, the number of virtual links increases rapidly, leading to a rapid increase in network bandwidth demand. In this case, the NIC bandwidth capacity will become a resource bottleneck, which becomes more and more severe as the number of virtual nodes per virtual network increases. This bottleneck will lead to reduced efficiency of other resources in the same resource pool. In a disaggregated architecture, this problem may be solved by scaling the NIC resources in each resource pool.

To show the scalability of the disclosed algorithms, the variation of the running time with the problem size is further evaluated. Specifically, this example considers a disaggregated data center with 4 resource pools, each containing 3 h, h, 2 h, 2 h, and 2 h CPU, memory, NIC, A1, and A2 nodes, respectively, where h∈{1, 2, 3, 4, 5} is defined as the scaling parameter. Accordingly, the total number of resource nodes in this disaggregated data center is 40 h. Moreover, the disaggregated data center has 4 ToR, 2 aggregation, and 2 core switches. Additionally, this example considers a single virtual network request for the test, and the number of virtual nodes within this virtual network is 6 h. The remaining settings are the same as the previous simulation settings.

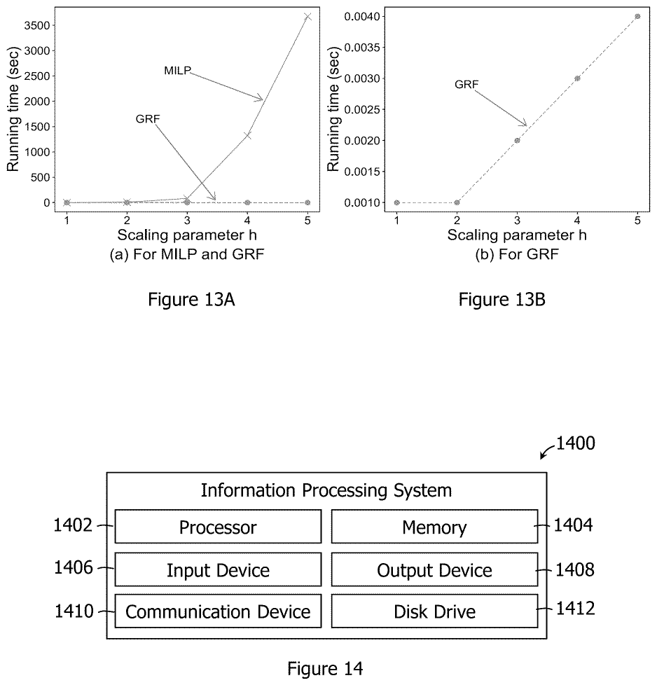

The graphs in FIGS. 13A and 13B show the variation in running time with the scaling parameter h. Since the difference in running time between MILP (up to one hour) and GRF (up to 4 milliseconds) is too large, to clearly observe the trend of GRF, a dedicated figure, FIG. 13B, is included. A small number of virtual nodes within a virtual network will result in a small number of virtual links. Therefore, the scheduling for such a virtual network can be completed very quickly. Thus, the running time at the scaling parameter of 1 and 2 is very close to each other. The running time of MILP tends to grow exponentially relative to the sizes of the disaggregated data center and the virtual network requests, making it unsuitable for large cloud data centers with millions of nodes. In contrast, the running time of GRF shows a linear growth trend with the problem size, demonstrating its scalability.

The numerical results have demonstrated that GRF, GLF, and MILP can significantly outperform the baselines, FF and BF, in terms of both acceptance ratio and energy efficiency. It is found that employing the remote-memory-first partition strategy may achieve improved performance over the local-memory first partition strategy in various scenarios (although the local-memory first partition strategy may outperform the remote-memory-first partition strategy in cases where each CPU node has sufficient local memory capacity). Considering that local memory is typically limited in capacity and needs to be disaggregated for efficient memory scalability, the algorithm with the remote-memory-first partition strategy may be more appealing for disaggregated data center architectures. The greedy algorithm with the remote-memory-first partition strategy can obtain a similar performance as MILP in terms of acceptance ratio and energy efficiency for small-scale problem. The high scalability of the greedy algorithm with the remote-memory-first partition strategy has been demonstrated. Thus, in the context of a relatively large-scale problem, if the MILP running time is excessive, the greedy algorithm with the remote-memory-first partition strategy may be used instead.

It should be noted that in practice, the sizes of different arriving services/requests can vary significantly. Thus, the disclosed techniques, which optimize the accommodation process for each service request, may not be able to achieve the goal of maximizing the revenue or profit of the data center operator/owner.

The disclosure herein has demonstrated that the virtual network embedding scheme and algorithms in some embodiments are suitable (e.g., optimal) for disaggregated data center. In some cases, the virtual network embedding scheme and algorithms may realize high energy efficiency as well as a high acceptance ratio.

The disclosure herein provides has provided various techniques for virtual network embedding for disaggregated data center.

For example, in some embodiments, there is provided a scheme for virtual network embedding in a disaggregated data center. In the scheme, for each arriving virtual network request, if sufficient resources are available to accommodate the request, the request is accepted and embedded in a way such that the overall power consumption of the disaggregated data center is minimized after accepting this virtual network request. Alternatively, if insufficient resources are available to accommodate the request, the request is rejected. Various methods or techniques, including MILP and greedy algorithm, may be applied to implement this scheme.

For example, in some embodiments, there is provided a mixed-integer linear programming (MILP) formulation for embedding a virtual network request. In the MILP formulation, it may be assumed that the remaining resources in the disaggregated data center system are sufficient to accommodate the incoming request. The objective of the MILP is to minimize the system power consumption after scheduling the request. The incoming request can be embedded in the disaggregated data center by solving the MILP formulation using a commercial solver Gurobi with Python. If a feasible solution cannot be found, the request is rejected.

For example, in some embodiments, there is a greedy algorithm for embedding a virtual network request. The greedy algorithm can have different variants with different memory partition operations. For large network cases, MILP may not be applicable as its not scalable due to its high time complexity and so the greedy algorithm is provided for virtual network embedding. The greedy algorithm may exhibit low time complexity and can offer an efficient solution for the embedding.

FIG. 14 shows an information processing system 1400 in one embodiment. FIG. 14 only illustrates main components of the information processing system 1400. The information processing system 1400 can support virtual network embedding for disaggregated data center.

For example, the information processing system 1400 can be used to perform processing operations such as those disclosed herein. For example, the information processing system 1400 can be used to implement the data center or a server of the data center disclosed herein. For example, the information processing system 1400 can be arranged to perform method 100. For example, the information processing system 1400 can be arranged to provide at least part of the system 200. For example, the information processing system 1400 can be arranged to support implementation of the virtual network embedding in FIG. 3. For example, the information processing system 1400 can be arranged to support implementation of the candidate pool selection in FIG. 4. For example, the information processing system 1400 can be arranged to perform at least part of Algorithm 1, at least part of Algorithm 2, and/or at least part of Algorithm 3 disclosed herein.

The information processing system 1400 includes components necessary to receive, store, and execute appropriate computer instructions, commands, and/or codes. The information processing system 1400 includes a processor 1402 and a memory 1404. The processor 1402 may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions (e.g., associated with any of the methods or operations disclosed herein), and/or to process signals and/or information and/or data. The memory 1404 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data are stored in the memory 1404. For example, computer instructions for executing or facilitating executing of the method steps or operations disclosed herein may be stored in the memory 1404. The processor 1402 and memory 1404 may be integrated (e.g., the processor may be considered to include memory), or the processor 1402 and memory 1404 may be separated (and operably connected).

Optionally, the information processing system 1400 further includes one or more input devices 1406. Examples of the input device 1406 include: keyboard, mouse, stylus, image scanner, microphone, tactile/touch input device (e.g., touch sensitive screen), image/video input device (e.g., camera), etc. The input device 1406 can be used to receive input from a user.

Optionally, the information processing system 1400 further includes one or more output devices 1408. Examples of the output device 1408 include: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive. The output device 1408 may be used to present information or data (e.g., virtual network mapping result) to a user.

The information processing system 1400 may further include one or more disk drives 1412 which may include one or more of: solid state drive, hard disk drive, optical drive, flash drive, magnetic tape drive, etc. A suitable operating system may be installed in the information processing system 1400, e.g., on the disk drive 1412 or in the memory 1404. The memory 1404 and the disk drive 1412 may be operated by the processor 1402.

Optionally, the information processing system 1400 also includes a communication device 1410 for establishing one or more communication links with one or more computing devices, such as servers, personal computers, terminals, tablets, phones, watches, internet connected (e.g., IoT) devices, or other computing devices. The communication device 1410 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, 6G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data.

The processor 1402, the memory 1404 (optionally the input device(s) 1406, the output device(s) 1408, the communication device(s) 1410 and the disk drive(s) 1412, if present) may be connected with each other, directly or indirectly, through any of: a bus, a Peripheral Component Interconnect (PCI), such as PCI Express, a Universal Serial Bus (USB), an optical bus, or other like structure. In one embodiment, at least some of these components may be connected wirelessly, e.g., through a network, such as the Internet, a cloud computing network, an edge computing network, etc.

One skilled in the art appreciates that the information processing system 1400 is merely an example embodiment and that in other embodiments the information processing system 1400 can have a different configuration (e.g., with additional components, fewer components, alternative components, etc.).

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of a particular function, the skilled person will understand that the functionality of the software application may be distributed across multiple routines, objects and/or components to achieve the same functionality desired herein. Further, where methods and systems are either wholly implemented by computing system or partly implemented by computing systems, any appropriate computing system architecture may be utilized. This may include stand-alone computers, network computers, dedicated or non-dedicated hardware devices. Where the terms “computing system” and “computing device” are used, these terms are intended to include any appropriate arrangement of computer or information processing hardware capable of implementing the function described.

It will be appreciated by one skilled in the art that variations and/or modifications may be made to the described and/or illustrated embodiments to provide other embodiments. The described/or illustrated embodiments should therefore be considered in all respects as illustrative, not restrictive.

Unless otherwise specified, terms of degree such that “generally”, “about”, “substantially”, or the like, are used herein to account for one or more of the following: manufacture tolerance, degradation, trend, tendency, imperfect practical condition(s), etc.

1. A method for virtual network embedding, comprising:
receiving a virtual network request including information defining a virtual network,
the information defining the virtual network comprising
a set of virtual nodes,
a set of virtual links operably connecting the set of virtual nodes, and
resource requirements associated with one or more of the virtual nodes; and
obtaining a mapping of the virtual network to resources of a disaggregated data center system based at least in part on the information defining the virtual network and an optimization algorithm arranged to optimize power consumption associated with the disaggregated data center system.

2. The method of claim 1, wherein the optimization algorithm is arranged to minimize power consumption associated with the disaggregated data center system.

3. The method of claim 2, wherein the disaggregated data center system comprises:
a plurality of resource pools each comprising
a plurality of resource nodes, and
interconnects arranged to operably connect the plurality of resource nodes; and
a data center network operably connected with the plurality of resource pools, the data center network comprises
a plurality of switch nodes, and
a plurality of links arranged to operably connect the plurality of switch nodes and to operably connect the plurality of switch nodes with the resource pools.

4. The method of claim 3, wherein the plurality of resource nodes comprises:
one or more processor nodes each provided by one or more processors with processing and memory resources,
one or more memory nodes each provided by one or more memory modules with memory resources, and
one or more network adaptor nodes each provided by one or more network adaptors; and
optionally, one or more accelerator nodes each provided by one or more accelerators.

5. The method of claim 4, wherein the plurality of switch nodes comprises:
one or more switch nodes each provided by a top-of-rack (TOR) switch,
one or more switch nodes each provided by an aggregation switch, and
one or more switch nodes each provided by a core switch.

6. The method of claim 5, wherein the mapping is arranged to:
map each of the virtual nodes to, at least, one or more processor nodes and/or one or more memory nodes, and
map each of the virtual links to, at least, one or more of the interconnects and/or one or more of the links.

7. The method of claim 6, wherein the mapping is arranged to:
map each of the virtual nodes to at least two resource nodes of the same resource pool,
map at least two of the virtual nodes to the same resource node, and/or
map the virtual nodes to resource nodes of at least two resource pools.

8. The method of claim 7, wherein the optimization algorithm comprises a mixed-integer linear programming (MILP) algorithm.

9. The method of claim 8, wherein:
the MILP algorithm defines an objective function for optimizing power consumption associated with the resource nodes and the switch nodes in the disaggregated data center system after scheduling the virtual network request; and
the MILP algorithm comprises optimizing the objective function.

10. The method of claim 9, wherein the power consumption associated with the resource nodes and the switch nodes comprises static power consumption and dynamic power consumption.

11. The method of claim 10, wherein:
the MILP algorithm defines one or more constraints associated with mapping of the virtual nodes, one or more constraints associated with mapping of the virtual links, and one or more constraints associated with utilization of one or more of the resource nodes; and
the MILP algorithm comprises optimizing the objective function based at least in part on the one or more constraints.

12. The method of claim 7, wherein the optimization algorithm comprises a greedy algorithm.

13. The method of claim 12, wherein the greedy algorithm comprises:
a memory demand partition operation arranged to divide the memory demand associated with each of the virtual nodes into local memory demand, which can be satisfied by one or more processor nodes of the resource nodes, and remote memory demand, which can be satisfied by one or more memory nodes of the resource nodes;
a virtual node mapping operation; and
a virtual link mapping operation.

14. The method of claim 13, wherein the memory demand partition operation comprises a local-memory-first partition operation which prioritizes the local memory demand.

15. The method of claim 13, wherein the memory demand partition operation comprises a remote-memory-first partition operation which prioritizes the remote memory demand.

16. The method of claim 15, wherein the virtual node mapping operation of the greedy algorithm comprises:
identifying one or more candidate resource pools for each of the virtual nodes; and
starting from the virtual node with the least number of identified candidate resource pools,
(i) selecting a resource pool from the one or more candidate resource pools, the selected resource pool is the candidate pool for the highest number of virtual nodes;
(ii) identifying all virtual nodes that include the selected resource pool as the candidate resource pool;
(iii) for each of the identified virtual nodes, mapping the identified virtual node to, at least, one or more processor nodes and/or one or more memory nodes based at least in part on the resource requirements associated with the virtual node and the remaining capacity of processor and memory nodes in the selected resource pool; and
(iv) for each of the mapped virtual node, performing bandwidth allocation operation for allocating bandwidth associated with one or more network adaptor nodes to the mapped virtual node.

17. The method of claim 16, wherein the virtual node mapping operation of the greedy algorithm comprises:
performing a revoke-and-retry operation if the allocation of bandwidth for the mapped virtual node is unsuccessful, the revoke-and-retry operation comprises:
revoking the mapping of the mapped virtual node;
performing the bandwidth allocation for another mapped virtual node; and
if the mappings of all mapped virtual nodes have been revoked, excluding the selected resource pool from the candidate resource pool and repeating (i) to (iv).

18. The method of claim 17, wherein the virtual node mapping operation of the greedy algorithm comprises:
repeating (i) to (iv) until all virtual nodes are mapped.

19. The method of claim 18, comprising:
configuring the disaggregated data center system based at least in part on the mapping to embed or deploy the virtual network.

20. A system comprising:
at least one processor arranged to perform the method of claim 19.
